(19) United States
(12) Patent Application Publication
(10) Pub. No.: US 2018/0246718 A1
(43) Pub. Date: Aug. 30, 2018

(54) A SYSTEM AND METHOD FOR MULTI-ISSUE PROCESSORS

(71) Applicant: SHANGHAI XINHAO MICROELECTRONICS CO. LTD., Shanghai (CN)

(72) Inventor: Kenneth Chenghao LIN, Shanghai (CN)

(21) Appl. No.: 15/552,462

(22) PCT Filed: Feb. 19, 2016
(86) PCT No.: PCT/CN2016/074093

§ 371 Date: Aug. 21, 2017

(30) Foreign Application Priority Data
Feb. 20, 2015 (CN) 201510091245.4

(51) Int. Cl. G06F 9/22; G06F 9/30

(52) U.S. Cl. CPC G06F 9/226; G06F 9/30181

(57) ABSTRACT

The present invention provides a multi-issue processor system and method. When applied to processors, it is capable of achieving a high cache hit rate by filling the instruction to the cache which the processor core can directly access before the execution of an instruction. According to the technical solutions of this invention, for multi-issue processor systems which need instruction translation, it can improve the performance of the processor by avoiding repeated address translation.

### CROSS-REFERENCES TO RELATED APPLICATIONS

The application is the U.S. National Stage of International Patent Application No. PCT/CN2016/074093, filed on Feb. 19, 2016, which claims priority of Chinese Application No. 201510091245.4 filed on Feb. 20, 2015, the entire contents of all of which are hereby incorporated by reference.

### FIELD OF THE INVENTION

The present invention relates to the field of computers, communications, and integrated circuits.

### BACKGROUND

The most advanced processors use multi-issue technology to improve the performance. The front end of the multi-issue processor can provide multiple instructions to the processor core in one clock cycle. The multi-issue front end contains an instruction memory with a sufficient bandwidth to provide a plurality of instructions in one clock cycle and the instruction pointer (IP) can be moved to the next position at a time. The front end of the multi-issue processor can effectively handle fixed-length instructions, but the situation is complicated when handling variable-length instructions. A good solution is to convert the variable-length instructions into fixed-length micro-operations (μOps) and then the processor front-end issues them to the execution. The number of μOps obtained by the conversion can differ from the number of instructions, since the length of the instructions varies. It is difficult to produce a simple and clear relationship between an instruction address (IP) and a μOp address,

The above problem makes it difficult to locate the μOp address corresponding to the program entry. For example, for a branch target of a branch instruction, the processor gives the instruction address (IP) instead of the μOp address. The prior art solution is to align the address of the μOp corresponding to the program entry to the cache block boundary which stores the μOp, rather than aligning the 2ⁿ address with the block boundary. FIG. 1 is an embodiment in which a variable-length instruction is converted to μOps according to the prior art, and then the [symbol] Ops are stored into a μOp cache to be sent by the processor front end for the execution of the processor core. Wherein the L1 cache 11 is used to store instructions, whose corresponding tag unit 10 is used to store the tag portion of the instruction address. The instruction convertor 12 is used to convert the instruction to a micro operation (μOp). A micro operation cache ( [symbol] Op cache) 14 is used to store the μOp of the conversion, and the corresponding tag unit 13 is used to store the instruction tag and the offset as well as the byte length of the instruction corresponding to the μOp stored in the μOp cache 14. Level 1 tag unit 10, L1 cache 11, tag unit 13, and [symbol] Op cache 14 are all addressed by the index portion of the instruction address. The processor core 28 produces an instruction address 18, and also an branch instruction address 47 which addresses the branch target buffer (BTB) 27. BTB 27 outputs branch judgment signal 15 to control the selector 25. When the branch prediction signal 15 from BTB 27 is ‘0’ (which means no branching), selector 25 chooses instruction address 18; when the signal is (which means branching), selector 25 chooses the branch target instruction address 17 from the output of BTB 27. The instruction address 19 output by selector 25 is then sent to the tag unit 10, L1 cache 11, tag unit 13, and [symbol] Op cache 14. According to the index part of instruction address 19, a set of context scans are selected from both target unit 13 and [symbol] Op cache 14. The tag portion and the offset from instruction address 19 can be matched with the tag portion and the offset stored in all the ways in the content set read from tag unit 13. If there is a match, the output hit-signal 16 controls the selector 26 to choose the plurality μOps in the corresponding way in the set of content output by the [symbol] Op cache 14. If no match is successful, the output hit-signal 16 controls the selector 26 to select the output of the instruction converter 12, which waits for the instruction address 19 to match the level 1 tag unit 10, and the plural instructions read from the L1 cache are converted into plural numbers of μOp and then stored in the μOp buffer 14 and at the same time output by selector 26 to the processor core 28 for execution. The instruction address and instruction length corresponding to those [symbol] Ops are also stored in the [symbol] Op tag unit 13. The byte length of the instruction, which corresponds to the plural [symbol] Ops stored in the ways hit by tag unit 13, is also sent to processor core 28 via bus 29, thus allowing the instruction address adder to add the byte address and the original instruction address to obtain the address of the next instruction. In some microprocessors, the instruction address generator and BTB are combined into separate branch units, but the principle is the same as above, and therefore no further explanation is made.

The disadvantage of the above technique is that each instruction block in the L1 cache may correspond to a plurality of program entry points, and each program entry point occupies one way of the tag unit 13 and the μOp cache 14, so that the contents of the tag units 13 and the μOp cache 14 are too fragmented. For example, a tag corresponding to an instruction block containing 16 instructions is ‘T’, where the instructions corresponding to bytes ‘3’, ‘6’, ‘8’, ‘11’ and ‘15’ are all program entry points. At this point, the instruction block occupies only one of the tag units 10 to store the tag ‘T’ and occupies only one way of the L1 cache 11 to store the corresponding instruction. However, the μOp obtained from the conversion of this instruction block requires occupying 5 ways in tag unit 13, respectively storing the tags and the offsets ‘T3’, ‘T6’, ‘T8’, ‘T11’ and ‘T15’ (the locations of these tags of 5 ways in tag unit 13 could be discontinuous). Store all of the complete [symbol] Ops into the corresponding 5 ways of [symbol] Op cache 14, starting from the corresponding program entries and the full capacity of their ways. If the corresponding μOp of an instruction cannot fit in the remaining capacity of a μOp block in a way, another way needs to be allocated. This caching organization causes duplication of the μOp tag in the tag unit 13, which also creates a dilemma. A larger μOp cache 14 block size, will cause more duplication, thus reducing effective capacities. A smaller μOp cache block size causes severe fragmentation. These shortcomings result in current processors using the above technology have a smaller cache capacity relative to the L1 cache, and contains duplication in [symbol] Op cache, thus making the effective capacity to further reduce, resulting in a cache miss rate greater than about 20%. The μOp cache's high miss rate, the high latency of instruction conversion when a miss occurs, and repeatedly converting the instructions all contribute to the high consumption and inefficiency of this type of processors. The same is true for other cache organizations such as trace cache and block cache.

This application discloses a method and system which directly solve one or more of the above, or other problems.

### BRIEF SUMMARY OF THE DISCLOSURE

The present invention provides a multi-issue processor system comprising: a front-end module and a back-end module, wherein the said front-end module further comprises: an instruction converter for converting instructions into μOps and generating mapping relationships between instruction addresses and μOp addresses; L1 cache, used to store the converted μOps, and send plural [symbol] Ops to back-end module for execution based on the instruction address sent by the back-end module; a tag unit, used to store the tag portion of the instruction address corresponding to the [symbol] Ops in the L1 cache; a mapping unit consisting of a storage unit and a logical operation unit; wherein the storage unit stores the mapping relationship of the μOp addresses in L1 cache and the addresses of instructions corresponding to those [symbol] Ops; and the logical operation unit converts instruction addresses into μOp addresses or converts μOp addresses into instruction addresses according to the mapping relationship; the back-end module includes at least one processor core for executing μOps sent by the front-end, and produce the next instruction address sent to the front-end module.

The present invention also discloses a multi-issue processor method, wherein the following method is embedded in the front-end module: converting the instruction into μOps and generating a mapping relationship between the instruction address and the μOp addresses; Storing the converted μOps in the level 1 cache and outputting a plural μOps to the back-end module according to the instruction address sent from the backend module; storing the tag portion of the instruction address corresponding to the μOps in level1 cache; storing a mapping relationship between the addresses of the μOps in level1 cache and the addresses of the instructions corresponding to those μOps; converting the instruction addresses into μOp addresses or converting the μOp addresses into instruction addresses according to the mapping relationship; The back-end module executes a plural μOps sent by the front-end module and sends the next instruction address to the front-end module based to the execution result.

The present invention also provides a multi-issue processor system comprising: a front-end module and a back-end module; wherein that the back-end module includes at least one processor core for executing a plurality of instructions sent by the front-end module, and generate the next instruction address to the front-end module; The front end module further comprises: a level1 cache for storing instructions and outputting a plurality of instructions to the back-end module for execution according to the instruction address sent from the back-end module; a tag unit for storing a tag portion of an instruction address corresponding to an instruction in the level1 cache; A level 2 cache for storing all instructions stored in the L1 cache, branch target instructions for all branch instructions in the level1 cache, and the sequential next instruction block of each instruction block in level1 cache; a scanner for reviewing instructions from the level2 cache to the level1 cache or instructions converted from the method described above, extracting the corresponding instruction information and calculating the branch target address of the branch instruction; a track table for storing the location information of all the instructions in the L1 cache, the branch target location information of the branch instruction, and the sequential next instruction block location information of level 1 instruction blocks. The said location information of the branch target or the sequential next block address is the location information of the corresponding branch target instruction in the level1 cache, if the branch target or the next block of the sequential address is already stored in the L1 cache. The location information of the branch target or the sequential next block is the location information of the corresponding instruction stored in the level2 cache, if the branch target is not yet stored in the L1 cache,

The present invention also provides a multi-issue processor method, wherein: the back-end module sends the next instruction address to the front-end module by executing a plurality of instructions sent by the front-end module; in the front-end module: Storing instructions in the L1 cache and outputting a plurality of instructions to the back-end module for execution based on the instruction address sent from the backend module; storing the tag portion of the instructions address corresponding to the instruction in level1 cache; store all instructions stored in the L1 cache, branch target instructions for all branch instructions in the level1 cache, and the sequential next instruction block of each instruction block in level1 cache; scans the instructions from the level cache to the level 1 cache or instructions converted by instruction conversion, and extract the corresponding instruction information and calculate the branch target address of the branch instruction; store to track table the location information of all the instructions in the L1 cache, the branch target location information of the branch instruction, and the sequential next instruction block location information of level 1 instruction blocks. The said location information of the branch target or the sequential next block address is the location information of the corresponding branch target instruction in the level1 cache, if the branch target or the next block of the sequential address is already stored in the L1 cache. The location information of the branch target or the sequential next block is the location information of the corresponding instruction stored in the level2 cache, if the branch target is not yet stored in the L1 cache.

Other aspects of the invention may be understood and appreciated by those skilled in the art from the description, claims and drawings of the present invention.

### Advantage of the Invention

The system and method of the present invention may provide a basic solution for the cache structure used by the variable-length instruction multi-issue processor system. In the traditional variable-length instruction processor, the address relationship between the instructions and the μOps is difficult to determine, and the number of μOps obtained by the instruction conversion of the fixed byte length is different, resulting in low memory efficiency and low hit rate of the cache system. According to the invention, the system and method establish a mapping relationship between the instruction addresses and the micro-operation addresses, and the instruction addresses can be directly converted into μOp addresses according to the mapping relation and read out the required μOps from the cache accordingly, thus improve cache efficiency and hit rate.

The system and method of the present invention can also fill the instruction cache before the processor executes an instruction to avoid or sufficiently hide cache misses.

The system and the method of the invention also provide a branch instruction selection technique based on the branch prediction bit, which avoids the access of the branch target buffer in the traditional branch prediction technology, thus not only saving the hardware, but also improving the branch prediction efficiency.

In addition, the system and method of the present invention also provides a branch processing technique without performance loss. branch prediction, The system and method eliminates branch penalty without employing branch prediction,

Other advantages and applications of the present invention will be apparent to those skilled in the art.

### BRIEF DESCRIPTION OF THE DRAWINGS

FIG. 1 is an embodiment in which a variable length instruction is converted to a micro-operation according to the prior art and stored in a μOp cache for execution by a processor front-end to a processor core;

FIG. 2 is an embodiment of the caching system of the present invention;

FIG. 3 is an embodiment of a row of memory cells and a corresponding μOp block in the mapping module of the present invention;

FIG. 4 is an embodiment of the command converter of the present invention;

FIG. 5 is an embodiment of the offset address mapping module of the present invention;

FIG. 6 is an embodiment of the mapping module of the present invention;

FIG. 7 is another embodiment of the caching system of the present invention;

FIG. 8 is an embodiment of the block offset mapping module of the present invention;

FIG. 9 is an embodiment of a cache system including a track table according to the present invention;

FIG. 10 is an embodiment of a track table based cache system according to the present invention;

FIG. 11 is an embodiment of a multi-launch processor system using a compressed track table;

FIG. 12 is an embodiment of the address format of the present invention;

FIG. 13 is an embodiment of two subsequent μOps of branch μOp;

FIG. 14 is an embodiment in which the branch prediction value control cache system stored in the track table provides μOps to the processor core 98 for its speculative execution;

FIG. 15 is an embodiment of the instruction read buffer of the present invention;

FIG. 16 is an embodiment of a multi-issue processor system that uses two [symbol] Op branches provided by both instructions read buffer and L1 cache simultaneously;

FIG. 17 is an embodiment of a processor system address format when a fixed-length instruction is executed;

FIG. 18 is an embodiment of the hierarchical branch flag system of the present invention;

FIG. 19 is an embodiment of a hierarchical branch flag system and an address pointer of the present invention;

FIG. 20 is an embodiment of a multi-issue processor system of the present invention in which the instruction read buffer provides a multi-layer branch of [symbol] Ops to a processor core at a same time.

FIG. 21 is an embodiment of the present invention in which the branch judgment cooperates with a flag to discard part of the μOps;

FIG. 22A is an embodiment of an out-of-order multi-issue processor core of the present invention;

FIG. 22B is another embodiment of the out-of-order multi-issue processor core of the present invention;

FIG. 23 is an embodiment of a controller of the present invention which uses flags to coordinate instruction read buffer and processor core operations;

FIG. 24 is an embodiment of the structure of the reordering buffer entry set of the present invention;

FIG. 25 is an embodiment of an instruction read buffer of the present invention which can be used as a reserved station or a scheduler storage entry;

FIG. 26 is an embodiment of the scheduler of the present invention;

FIG. 27 is an embodiment of the L1 cache of the present invention;

FIG. 28 is another embodiment of a multi-issue processor system of the present invention in which the instruction read buffer provides a multi-layer branch of [symbol] Ops to a processor core at a same time.

### DETAILED DESCRIPTION

Reference will now be made in detail to exemplary embodiments of the invention, which are illustrated in the accompanying drawings in connection with the exemplary embodiments. By referring to the description and claims, features and merits of the present invention will be clearer to understand. It should be noted that all the accompanying drawings use very simplified forms and use non-precise proportions, only for the purpose of conveniently and clearly explaining the embodiments of this disclosure.

It is noted that, in order to clearly illustrate the contents of the present disclosure, multiple embodiments are provided to further interpret different implementations of this disclosure, where the multiple embodiments are enumerated rather than listing all possible implementations. In addition, for the sake of simplicity, contents mentioned in the previous embodiments are often omitted in the following embodiments. Therefore, the contents that are not mentioned in the following embodiments can be referred to in the previous embodiments.

Although this disclosure may be expanded using various forms of modifications and alterations, the specification also lists a number of specific embodiments to explain in detail. It should be understood that the purpose of the inventor is not to limit the disclosure to the specific embodiments described herein. On the contrary, the purpose of the inventor is to protect all the improvements, equivalent conversions, and modifications based on spirit or scope defined by the claims in the disclosure. The same reference numbers may be used throughout the drawings to refer to the same or like parts.

In addition, some embodiments have been simplified in the present specification in order to provide a clearer picture of the technical solution of the present invention. It is to be understood that altering the structure, delay, clock cycle differences and internal connection of these embodiments within the framework of the technical solution of the present invention is intended to be within the scope of the appended claims.

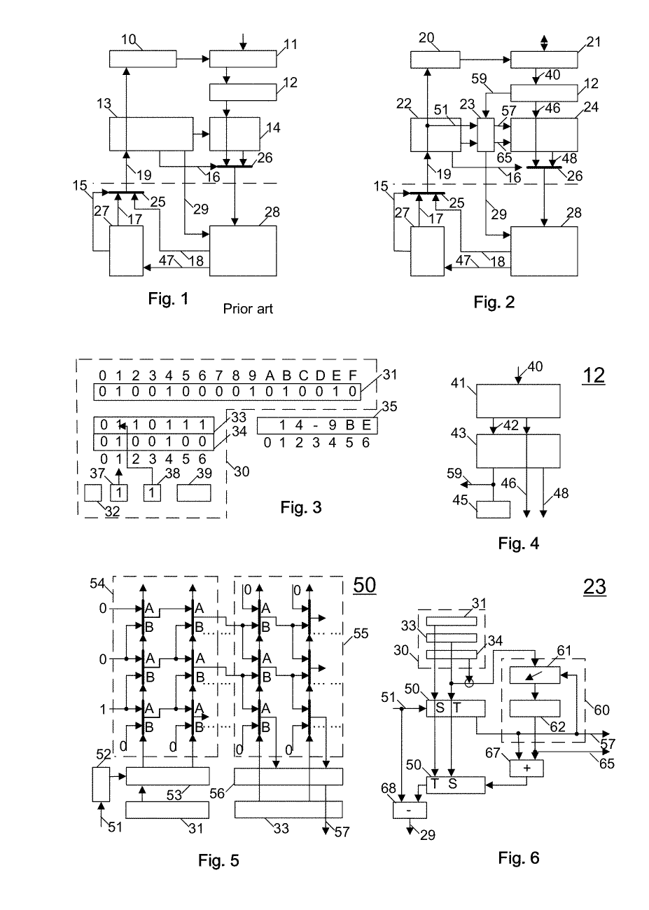

The method and system in this disclosure uses a 2ⁿ address boundary-aligned L1 cache to store μOps, thereby avoiding the fragmentation and repetitive memory dilemmas inherent in μOp cache or other similar caches aligned with program entry points. Referring to FIG. 2, which is an embodiment of the caching system of this disclosure, wherein the level 2 tag unit 20 is used to store the tag of the instruction address, and the L2 cache 21 is used to store the instruction. The format of the instruction address in this example still contains tags, indexes, and offsets. The instruction converter 12 is used to convert instructions to μOps. The level 1 tag unit 22 is used to store the tags in the instruction address, and the L1 cache 24 is used to store the converted μOps. In this example, the level 2 tag unit 20, the L2 cache 21, the level 1 tag unit 22, and the L1 cache 24 are each addressed by the index portion of the instruction address to output a set of cache contents. The address mapper 23 is used to convert the intra-block offset of the instruction pointer (IP) into the corresponding μOp block offset address (BNY), so that it is possible to read a plurality of μOps from the μOp offset address in the set selected by the index in the L1 cache 24. In addition, the address mapper 23 also provides the μOp read width 65 to the L1 cache 24 to control the number of μOps to be read, and the μOp read width 65 is converted to the corresponding instruction read width 29 to the processing core 28 for the inside instruction address adder to calculate the next instruction address 18 for the next clock cycle. The modules 25, 27, 28, and the buses 15, 16, 17, 18, 19 and 29 below the dashed line in FIG. 2 are the same as those in the embodiment of FIG. 1. Thus, the interface at the dotted line in FIG. 2 is consistent with FIG. 1. That is, the same function as in the embodiment of FIG. 1 can be implemented by replacing the upper portion of the dashed line in FIG. 1 with the upper portion of the dashed line in FIG. 2 in cooperation with the processor core 28, the branch target buffer (BTB) 27, and the selector 25. In contrast to the embodiment of FIG. 1, the hit rate of the L1 cache 24 in this example is similar to that of the ordinary L1 cache, thereby significantly improving the performance of the system.

In this example, a block in L1 cache corresponds to a block in L2 cache. That is, a L1 cache block can accommodate all the [symbol] Ops converted from all the instructions stored in a block in L2 cache. In variable-length instruction processor systems, an instruction often crosses the boundary of the instruction block, that is, the front and rear parts of an instruction are located in two instruction blocks. In this case, the latter part of the instruction that crosses the boundary of the instruction block is also classified as the instruction block belonging to the first half of the instruction block. Thus, all the μOps corresponding to the instructions that cross the boundary of the instruction block are stored in the L1 cache block corresponding to the instruction block in which the first half of the instruction is located, and the first μOp in each L1 cache block corresponds to the first instruction from the corresponding L2 cache block. Thus, the index on the instruction pointer 19 (IP) is used to select a set from the L1 cache 24, the tag of the instruction address 19 is used to match the corresponding ways in the set, and the address mapper 23 converts the offset 51 of the instruction pointer 19 to the μOp offset address BNY 57 to select the corresponding plurality of μOps starting from BNY in those matched ways. If the L1 cache match success signal 16 indicates “match success”, then the selector 26 selects the plural μOps output from the L1 cache 24. Else if the first-level cache matching success signal 16 indicates “match unsuccessful”, the L2 cache 21 is accessed according to the instruction pointer 19 in the usual way, that is, a set is selected according to the index of instruction pointer 19 and the tag in instruction address 19 are matched with the corresponding tags of the set, so that the desired instruction block is found in L2 cache 21. The instruction block output by the L2 cache 21 is converted to μOps by the instruction converter 12 and stored in L1 cache 24 while being sent to the processor core 28 via selector 26 simultaneously. In this process, once the instruction converter 12 determines that the last instruction in the sub-block crosses the block boundary, it calculates the address of the next instruction block by adding the current instruction block address to the byte length of the instruction block, and send the next block address to the level 2 tag unit 20 and the L2 cache 21 to acquire the corresponding L2 cache block and to convert the latter half of the instruction that crosses the block boundary. So that it can convert all the instructions in original L2 cache blocks to micro-operations and store them in L1 cache 24 and send them to the processor core 28 for execution. The L1 cache 24 supports reading consecutive μOps from any offset address in one block, which can be implemented by reading a whole [symbol] Op block from L1 cache 24 according to a block address and using a selector net or a shifter to select several consecutive [symbol] Ops which begin from the address of BNY 57 and have a length specified by reading width 65. Alternatively, a fixed number of consecutive μOps from 57 can be sent from 24 at each clock cycle, and the read width 65 can be sent to the processor 28, to determine the effective μOps therein.

The address mapper 23 includes a memory unit and a logical operation unit. The rows of the memory cells in 23 correspond to the μOp blocks in the L1 cache 24 and are addressed by the methods and tags of the same instruction address 19 as described above. Each row of the address mapper 23 stores the correspondence between the instructions in the instruction block in the L2 cache and the μOp in the μOp block in the L1 cache, for example: the fourth byte in the L2 cache sub-block is the start byte of an instruction and corresponds to the second μOp in the corresponding L1 cache block. In the embodiment of FIG. 2, instruction converter 12 is responsible for generating the correspondence relationship when the instructions are switched. The instruction converter 12 records the start byte address, offset, and the BNY of the translated [symbol] Ops of each instruction. This recorded information is sent to the address mapper 23 via bus 59 and stored in the memory cell row corresponding to the L1 cache block that stores those μOps. FIG. 3 shows one embodiment of a memory cell in the address mapper 23 and one embodiment of a corresponding μOp block. The entry 31 corresponds to a variable-length instruction block in the L2 cache, where each bit corresponds to one byte in the sub-block. When the corresponding bit is ‘1’, the byte corresponding to that bit is the start byte of an instruction. Similarly, the entry 33 corresponds to a μOp block in the L1 cache, with each bit corresponding to a μOp. When a bit is ‘1’, it indicates that the μOp this bit represents corresponds to a ‘1’ in entry 31, representing a starting point of an instruction in the same order. The hexadecimal number above the entry 31 corresponds to the byte offset of the instruction address, and the number below entry 33 corresponds to BNY. Based on the entries 31 and 33, the logical operation unit in the address mapper 23 can map the IP offset 51 of any instruction entry point to its corresponding μOp in-block offset BNY 57. In addition, the entry 34 and 35 correspond to the same μOp block as shown in entry 33, but each bit of entry 34 corresponds to a branch μOp, that is, the bit value corresponding to a branch μOp is ‘1’, and the remaining bit values are ‘0’s; and the entry 35 is a level 1 buffer block of the L1 cache 24, in which the instruction corresponding to each μOp is indicated by the offset address in the instruction block, and the ‘-’ flag indicates the μOp is not a starting μOp of any instructions. The μOps corresponding to every bit in 33, 34, and 35 are one-to-one correspondence, and are aligned by the most significant BNY (right align), so that the bits of BNY ‘6’ in table 33, 34, and 35 correspond to the μOps in entry 31 starting from ‘E’ bytes. The BNY output from the pointer 37 is ‘1’, pointing to the μOps whose BNY equals ‘1’ in entry 33, indicating that there is no effective μOp (BNY is less than ‘1’) before itself in that μOp block. The offset output by pointer 38 is also ‘1’, pointing to the instruction whose byte address in the entry 31 is ‘1’, indicating that the instructions before the byte in the instruction block are not converted to μOps.

In addition, since the number of μOps corresponding to each variable-length instruction sub-block may not be the same, the L1 cache memory space could be wasted if the L1 cache block size is determined according to the maximum number of possible μOps. In this case, it is possible to appropriately reduce the size of the μOp block and increase the number of μOp blocks, and add a corresponding entry 39 for each μOp block for recording the address information of other [symbol] Op blocks which correspond to the same variable-length instruction. Please refer to the following examples for specific construction and operation.

Referring to FIG. 4, when the instruction converter 12 starts the instruction conversion from an instruction entry point, the L2 instruction block is sent via bus 40 to the instruction translation module 41 in the instruction converter 12. The instruction translation module 41 starts converting instructions from the instruction entry point and determines the starting point of the next instruction with the instruction length information contained in the instruction, so that translates all the instructions whose starting points are between the instruction entry point and the last byte of the L2 cache block (including entry point and last byte) into μOps. The resulting μOps are sent via bus 46 and selector 26 to processor core 28 for the execution, and is also stored via bus 46 to a buffer 43 in instruction converter 12. The instruction translation module 41 also marks the start byte address of each instruction as ‘1’, stores them in the buffer 43 via the bus 42 according to their IP offset address, and mark the start bit of [symbol] Ops and the μOps corresponding to the branch instructions as ‘1’, and store them in the same order into the buffer 43 via bus 42. The counter 45 in the instruction converter 12 starts to count at the same time, the initial default value of which is the capacity of the L1 cache block, and each time a μOp is made and stored in the buffer, and the counter value is decremented by ‘1’. When all the instructions in the L2 instruction block (including instructions extending to the next instruction block but starting at the present L2 instruction block) are converted to μOps, the instruction converter 12 sends all μOps in the buffer 43 to the L1 cache 24 via the bus 48. The [symbol] Ops are stored most significant bit (right) aligned in a L1 cache block decided by cache replacement logic in L1 cache 24. The corresponding tag portion of the instruction address is also saved into the entry in L1 tag unit 22 which is corresponding to the way/set of this L1 cache block. At the same time, the record corresponding to the instruction start address in the buffer 43 in converter 12 is stored in the row of address mapper 23 corresponding to the L1 cache block, as shown in FIG. 3; The [symbol] Op start point record and the branch point record in the buffer are stored into entry 33 and 34 in address mapper 23 separately via bus 59, most significant bit (right) aligned; The value in counter 45 is also stored in the entry 37 of that row via bus 59, and the offset of the entry point is stored into entry 38 of that row via bus 59 as well.

Referring to FIG. 5, the instruction pointer offset in the instruction block of an entry point may be mapped by an offset address translation module 50 to the corresponding μOp address BNY. The offset address conversion module 50 is composed of a decoder 52, a mask 53, a source array 54, a target array 55, and an encoder 56. The n-bit binary block offset address 51 of the instruction entry point is translated by the decoder 52 into a 2n-bit mask corresponding to the bits of the address on the offset address 51 in the instruction block and the bits on the left side are all ‘1’, the remaining bits are ‘0’. The mask is sent to the mask 53 to perform an AND operation with the source correspondence of the memory unit 30 (in this example, entry 31) so that the bits which are less than or equal to the offset address 51 of output address of the mask 53 are the same as the entry 31, and the bits which are larger than the offset address 51 of the address 0 set to ‘0’. Each bit of the output of mask 53 controls a column selector of source array 54. When a bit is ‘0’, each selector in the selector column controlled by this bit selects the A input so that it selects the input of the same row on its left; when a bit is ‘1’, each selector in the selector column controlled by this bit selects the B input so that it selects the input of the next row on its left; And for the A input of selectors in the leftmost column of the source array 54, all of the inputs are ‘0’s except the bottom line being ‘1’s; while the selectors in the bottom line have the input B being all ‘0’s. The output of the rightmost column selector is the output of the source array 54. The bottom row of the leftmost column of the above-mentioned ‘1’ is shifted up by one row after it passes a column that is controlled by an output bit ‘1’ of the mask 53. After the bit goes through all the columns and outputted from the right side of the source array 54, the row index of that bit ‘1’ then represents the number of instructions before (and including) the entry point in the instruction block represented by entry 31.

The output of the source array 54 is sent to the target array 55 for further processing. The target array 55 is also composed of selectors, each column of which is controlled directly by the bit of the target correspondence (in this case, entry 33). When a bit is ‘0’, each selector in the selector column controlled by this bit selects the input B so that it selects the input of the same row on its left; when a bit is ‘1’, each selector in the selector column controlled by this bit selects the input A so that it selects the input of the next row on its left; And for the B input of selectors in the leftmost column of the source array 55, all of the inputs are connected to the output of source array 54, except the bottom line taking ‘0’ as input; the bits of input B of the selectors in the bottom line and the input A of the top line are all ‘0’s. The outputs of the bottom line of the selectors are sent to encoder 56. Each time a bit ‘1’ from a row in source array 54 passes a column controlled by entry 33 which has a value ‘1’, that bit will shift down a row. When it is outputted from the bottom of target array 55, the position of that ‘1’ bit is the position in L1 instruction block of the μOp which corresponds to the entry point instruction. That location information is encoded by the encoder 56 into a binary valued μOp block offset BNY and sent out via bus 57.

The offset address translation module 50 is essentially detecting the corresponding relationship of the ‘1’ values in the two entries. Therefore, the result will be the same either by counting the number of before an address in the first entry in order from least significant bit to most significant bit, or by counting the number of before an address in the first entry in reverse order from most significant bit to least significant bit, to obtain the number to be mapped to an address in the second entry. In this case, mask 53 sets the bit which is corresponding to the address sent from bus 51 and the subsequent bits of it to ‘1’s. In the following examples, sequential conversion is illustrated as an example for ease of understanding.

The logical operation unit of the address mapper 23 is shown in FIG. 6, which cooperates with the storage unit 30 to convert the instruction address offset 51 into the corresponding μOp offset address BNY 57 and outputs read width 65 (i.e. the number of the [symbol] Ops read at that time) and the instruction byte length 29 corresponding to these μOps. The μOp offset address 57 and the read width 65 control the L1 cache 24 to read a number of successive instructions starting from the BNY on the [symbol] Op offset address bus 57, and the number is determined by the read width 65. 29 provides the processor 28 with the corresponding instruction byte length of the μOp read at this time so that it can calculate the instruction address 18 for the next clock cycle. FIG. 6 also includes the same entry items 31, 33, and 34 as in the embodiment of FIG. 3, as well as a shifter 61, a priority encoder 43, two offset address conversion modules 50 (referred to as an up-conversion module 50 and a down-conversion module 50 based on the positions in FIG. 4), an adder 47, and a subtractor 48. When the L1 cache is accessed by the address on the command bus 19 in FIG. 2, a L1 cache block is selected and outputted from L1 cache 24 according to a way number, which is obtained from the match of the tag and index of bus 19 in tag unit 22, and the set number selected by the index bit on bus 19; the row selected by the row number and the set number in the memory cell 30 in the address mapper 23 is also read out. Wherein the entries 31, 33, and the value ‘4’ of block offset address 51 on the instruction bus 19 are mapped to BNY value ‘2’ by the conversion module 50, and then sent to L1 cache 24 via bus 57 to select the start μOp. The mapping principle has been described in FIG. 5, which will not be repeated here.

Different architectures may have different read width requirements. Some architectures allow the same number of instructions to be provided to the processor core per clock cycle, with no other conditional restrictions. The reading width 65 at this time can be a fixed constant. However, some architectures require that the μOps corresponding to one same instruction must be sent to the processor core together in a single clock cycle (hereinafter referred to as the “first condition”). Some architectures require that all μOps corresponding to a branch instruction must be the last μOps that are sent to the processor core in a single cycle (hereinafter referred to as “the second condition”). There are also certain architectures that require both the first and second conditions. In FIG. 6, the shifter 61 and the priority encoder 62 constitute a read width generator 60, which is used to generate a read width 65 that satisfies the first and second conditions to control the L1 cache to read the corresponding number of μOps in one clock cycle. The shifter 61 shifts the contents of the entries 31 and 34 to the left (fills ‘0’s from the right) by using the value in BNY 57 (in this case, ‘2’) as the shift bits. In the following description, the 0th bit output by the shifter 61 is the second bit of the entry 33 and 34 before the shift, and the remaining bits are handled in the same way. Assuming that the maximum read width of each clock cycle is 4 μOps, then the shifter 61 outputs the left 5 bits (i.e. the maximum read width plus 1) of the shift result ‘1011100’ which becomes ‘10111’, and the left 4 bits of the entry 34 shift to result in ‘0010000’ which is ‘0010’ to the priority encoder 62. The priority encoder 62 includes a leading 1 detector for checking whether the read width satisfies the first condition.

The leading 1 detector detects the shift result from the highest bit of the address (the address ‘4’) to the lowest bit of the address (the address ‘0’) (i.e. from the right to the left in this case) and outputs the address corresponding to the first ‘1’. Here, the bit corresponding to the address ‘4’ contains the first ‘1’, so the leading 1 detector outputs ‘4’, indicating that the maximum read width satisfying the first condition can reach ‘4’. The priority encoder 63 also includes a second leading 1 detector, which is used to output the address corresponding to the first ‘1’ by detecting from the lowest bit (which corresponds to address ‘0’) to the highest bit (which corresponds to address ‘3’) (i.e. from the left to the right in this case) of the 4 bits from the left of the shift result of entry 34 (i.e. ‘0010’). The output address is the first branch [symbol] Op address after the entry point; After that is the second detection step, which detect the shift result of the entry 33 (‘10111’) from the first branch [symbol] Op address (‘2’) to the highest bit of the address (‘4’) (i.e. from left to right in this case) and output the corresponding address of the first ‘1’. The output address in this example is ‘3’, which indicates that the maximum reading width is ‘3’ when the second condition is satisfied. The second detection step of the second condition is set to exclude the situation that a branch instruction can correspond to a single μOp or a plurality of μOps. If the corresponding branch instruction in the architecture can only be one μOp, it can append a ‘0’ to the left of the shift result of entry 34 to become ‘00010’, detect the corresponding address to the first ‘1’ in that result from the lowest bit (‘0’) to the highest bit (‘4’) (i.e. from left to right in this case) and output the detected address (‘3’ in this example) directly without the need of the second detection step. Other cases are like this one, for example, if each branch instruction in the architecture is always translated to two μOps, then it only need to append two ‘0’ bits to the left of the shift result of the entry 34 and detect the first ‘1’ from left to right and output the corresponding address. The priority encoder 62 outputs the smaller read width of the outputs of leading 1 detector and second leading 1 detector as the actual read width. Therefore, the read width 65 in this example is ‘3’, which is used together with the BNY 57 value ‘2’ to control the L1 cache 24 to read the 3 [symbol] Ops selected in one clock cycle (the corresponding BNY are ‘2’, ‘3’, and ‘4’) as is shown in FIG. 2. Those 3 [symbol] Ops are then output by selector 26 to processor core 28 for execution. Different architectures may have different requirements for read width, such as unrestricted, satisfying the first condition, satisfying the second condition, or satisfying both conditions. The above-mentioned read width generator can meet all four requirements, and other requirements can be met according to the basic principles. Depending on the conditions, the above read width generator can be trimmed until it is completely canceled and read at a fixed width. The embodiments disclosed in this specification are illustrated by the need to meet the first condition, and certain embodiments require meeting both the first condition and the second condition.

The adder 67, the down conversion module 50, and the subtractor 68 can convert the μOp read width in the form of BNY back to the number of bytes of the corresponding instruction. At this time, the adder 67 adds the value ‘2’ of the BNY 57 to the read width ‘3’, and the resulting result ‘5’ is sent to the decoder 52 in the down conversion module 50 (as shown in FIG. 5). Note that in FIG. 4, the connection of the down conversion module 50 to the address mapper 23 and the connection of the up conversion module 50 to the address mapper 23 are reversed, so that for the down conversion module 50, the entry 33 is sent to the mask 53, while the entry 31 is used to control the selection target array 55. As described in the previous example, the down conversion module 50 converts the input BNY value ‘5’ into the hexadecimal instruction address offset ‘B’. The subtractor 68 subtracts the instruction address offset ‘4’ on the bus 51 from the ‘B’, and the resulting result ‘7’ is the byte address 29, which is then sent to the instruction address adder in the processor core 28 so that the instruction address adder can correctly generate the next instruction address 18.

The processor core 28 pre-decodes the received μOps to determine the μOp of the BNY of ‘4’ (the instruction corresponding to the instruction address offset of ‘9’) is a branch μOp, and the branch instruction address is sent via bus 47 branch target buffer 27 to find the match. If the value of the matching branch prediction signal 15 indicates that the branch transition has not occurred, then the signal control selector 25 selects the instruction address 18 output from the processor core 28 as the new instruction address 19. This instruction address is obtained by adding byte increment ‘7’ on the basis of the original instruction address ‘4’, so the tag part and the index part of the instruction address are the same as before, but the value of the offset 51 is hexadecimal ‘B’. The index value of the new instruction address still points to the row of the previous index in the tag unit 22. Based on the matching result of the tag and offset parts of the new instruction, the entries in the address mapper 23 (entry 31, 32, 33, 34, 37, 38 and 39) which are corresponding to the matched items in that row are found, and the contents of those entries are read out. The IP offset on bus 19 is processed according to the method described in FIG. 6, and the value ‘B’ of the IP offset 51 is converted into the value ‘5’ of BNY 57 according to the correspondence relationship in entries 31 and 33. This value is greater than or equal to the value ‘1’ in the entry 37, so the μOp corresponding to the BNY of ‘5’ is valid. Therefore, the block address mapper 23 controls the L1 cache 24 according to the value on the 57 to read a number of μOps, which number is determined by the read width 65 from BNY ‘5’. If the value of the branch prediction signal 15 indicates that the branch transfer occurs, then the signal controls the selector 25 to choose the branch target address 17 output by BTB 27 to be the new instruction address 19 and then send the instruction address 19 to the tag unit 22, address mapper 23, etc. to perform the corresponding matching and conversion. When a branch entry point is already in an existing [symbol] Op block, use its IP tag and index part to read the corresponding row in the storage unit 30 in block address mapper 23. If the IP offset 51 value is less than the pointer in the entry 38, it indicates that the [symbol] Ops corresponding to that instruction is not stored in L1 cache yet. At this time, the system sends IP to the L2 tag 20 to be matched via bus 19, and reads the L2 instruction block from L2 cache 21 (the system can also do the L2 cache matching simultaneously with the L1 cache matching, rather than starting the L2 cache matching after the miss of L1 cache matching). The value of the above-mentioned entry 37 is sent to the counter 45 in the instruction converter 12, and the value of the entry 38 is sent to the instruction converter 12 for decrementing ‘1’ in the instruction translation module 41 and saved to the boundary register. The instruction translation module starts translating instructions to [symbol] Ops from the entry point until the IP offset in the instruction block is equals to the value in boundary register. The μOps of the conversion are performed by the processor core and stored in the buffer 43 in FIG. 4. The instruction start point record and the μOp start point record in the process and the branch μOp record are also stored in the buffer 43. The counter 45 is also counted down by the number of μOps stored. When the instructions which need to be converted are converted, the μOps are stored in buffer 43 starting from ‘1’ less than the value in entry 37 as BNY address in the order from more significant to less significant into the instruction block selected by the tag and index address within IP in level 1 cache 24. The records of the starting point of μOps and branch μOps are also stored in buffer 43 starting from ‘1’ less than the value in entry 37 as BNY address in the order from more significant to less significant into entry 33 and into entry 32. The record of instruction starting points are also stored in entry 31 based on their offset address. The storing above is selective partial write, which does not affect the storage or the existing part of the value in the entries. Finally, the count in counter 45 is stored in entry 37, and the Offset value of entry point is stored in entry 38. Also, only one of the entry 37 and 38 needs be saved, because the other can be obtained by mapping using the offset address conversion module 50 according to entries 31 and 33, and will not be described here.

If the instruction block is entered from the previous instruction block in the order of instruction execution, the entry point can be calculated from the information of the last instruction in the previous instruction block. The starting offset and the instruction length of the last instruction of the previous instruction block are known by the instruction translation module 41. From the instruction length (instruction block capacity—the starting address of the last instruction) to acknowledge the number of bytes that the last instruction occupies in the present instruction block, from which the starting address of the first instruction (sequential entry point) in this instruction block can be known. For example, if the instruction block has 8 bytes, the offset address of the last block of the last instruction block is ‘5’ and the instruction length is ‘4’, then (4−(8−5))=1. Then ‘1’ is the sequential entry point of this instruction block. The last instruction of the previous instruction block occupies the 4, 5, 6 bytes of the previous instruction block, and the ‘0’ byte of this instruction block. Therefore, the first instruction of this instruction block starts at ‘1’ bytes. If the instruction block does not have a corresponding L1 cache block, a L1 cache block is allocated by the L1 cache replacement logic. All the instructions starting from the sequential entry point in the present instruction block are converted into μOps and saved into the L1 cache block and the lines in the level 1 tag 22 and the address mapper 23 are created as above. If the instruction block has a corresponding level of cache block, like the example of the branch entry point above, it needs to compare the sequential entry point with the entry 38. If the sequential entry point address is less than the value of the entry 38, then translate the instruction from the sequential entry point to the address in the entry 38, and store the partial conversion result in that L1 cache block in the L1 cache 24 and the corresponding row entry in the address mapper 23 in the address mapper 30. Flag entry 32 can be added in the rows in 30. When the entry 32 is ‘1’, it indicates that the L1 cache block already contains all the μOps whose starting points are between the sequential entry point and the last byte of the corresponding instruction block are converted, and the entry 37 points to the first valid μOp corresponds to the sequential entry point in that L1 cache block. In this case, when entering a L1 cache block, it only needs to check whether the corresponding entry 32 is ‘1’. If the entry 32 is ‘1’, then: when a branch enters this L1 cache block, it does not need to compare the IP offset of the branch target with the entry 37, since the IP offset must be greater than or equal to the value in the entry 37; when entering this cache block sequentially, the value of the entry 37 can be directly used as the entry point, and it is not required to use the instruction translation module 41 to assist in calculating the entry point.

Depending on the needs of the processor core 28, the caching system may also provide instruction address offset or instruction address byte increment for branch instructions. In this case, the instruction address offset is the instruction address offset ‘9’ obtained by converting the sum ‘4’ of the μOp address ‘2’ and the number of μOps ‘2’; the instruction address byte increment is obtained by subtracting the current instruction address offset amount ‘4’ from the instruction address offset ‘9’ of the branch instruction (It can be reflected by the BNY of the branch μOp indicated by the entry 34 by the down conversion module 50 just like the above embodiment), and the result is ‘5’. Entries can also be set up for the branch instruction to record the IP offset address of the branch instructions, which the same as the entry 34. The caching system, particularly the address mapper 23, which contains all mapping relationships between instructions and μOps, can satisfy all the requirements of the processor core 28 for instruction or μOp access.

The buffer system (as indicated above in dashed line in FIG. 2) may work in conjunction with a processor core and a branch target buffer implemented by the prior art (as shown in the lower part of the dashed line in FIG. 2). At this point, the caching system has the same external interface as the μOp caching system implemented using the prior art. That is, the processor core or branch target buffer provides the instruction address; The caching system returns the μOps while satisfying the read width condition; In addition, the caching system also returns the byte increment corresponding to the μOps which have been read, so that the instruction address adder in the processor core can maintain the correct update of the instruction address, thereby ensuring that the correct branch target instruction addresses can be calculated. However, the cache described in the embodiment of FIG. 2 can convert the address of the variable-length instruction into the address of the fixed-length μOps to access the instruction memory aligned with the 2ⁿ-address boundary to avoid duplication of storage in the existing μOp cache, and the fragmentation problems. This cache system can significantly improve the cache hit rate as well as reducing power consumption and cost.

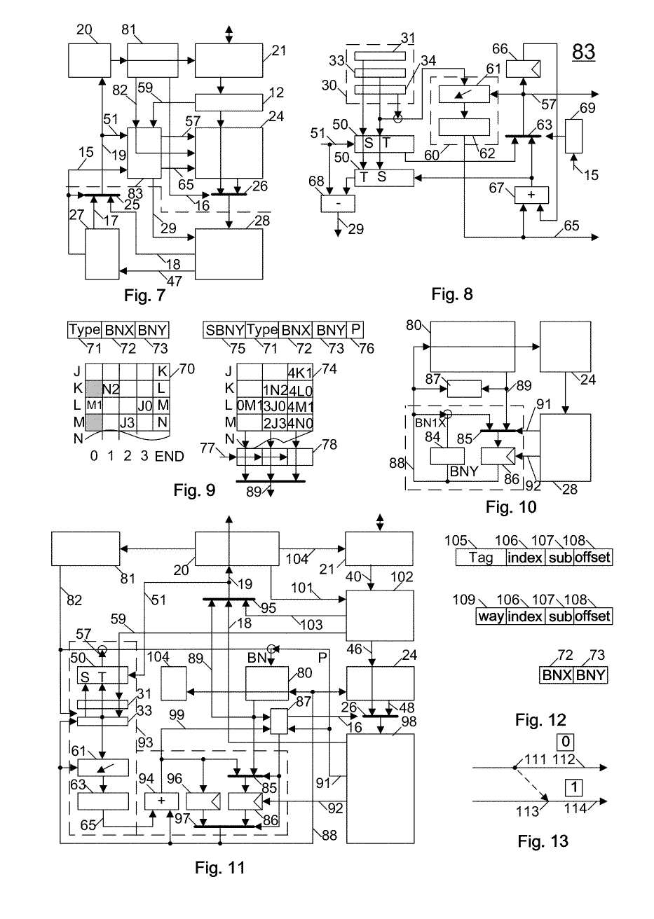

The embodiment of FIG. 7 shows an improvement of the embodiment of FIG. 2. In the embodiment of FIG. 7, the function of the L1 tag 13 in the embodiment of FIG. 2 is replaced by the block address mapping module 81 combined with the L2 tag 20, and the block offset mapping logic unit in FIG. 6 is further simplified. In this example, the L2 tag unit 20, the L2 cache 21, the L1 cache 24, the selector 26, and the buses 19, 51, 57, 59 are the same as those in the embodiment of FIG. 2; the modules 25, 27, 28 below the dashed line and the buses 15, 16, 17, 18, 29 and 47 are the same as those in the embodiment of FIG. 1. The block address mapping module 81 is added, and the block offset mapping module 83 replaces the address mapper 23 in the embodiment of FIG. 2. The L2 cache 21 still stores the instructions, and the L1 cache 24 still stores the μOps that are converted from the instructions. But each of the L2 cache blocks in the L2 cache 21 is divided into four L2 cache sub-blocks, and all instructions starting at each of the L2 cache sub-blocks are converted to μOps and stored into one L1 cache block. The memory address IP is divided into four segments, starting by the highest bits are the tag, the index, the sub-block address, and the offset. When the L2 cache is accessed by IP on the bus 19, the tag and index in the IP are matched with the L2 tag unit 20 in the embodiment of FIG. 2 and one L2 cache block is selected from the L2 cache 21. The sub-block address (2 bits in this example) further selects one of the four sub-blocks in the L2 cache block to output to the instruction converter 12. The [symbol] Ops, which are the outputs of the converter, are sent to processor core 28 for execution and are also stored into a L1 cache block selected by the replacement logic in L1 cache 24. The organization and addressing mode of the block address mapping module 81 is similar to that of the L2 cache 21. Each of the rows in the block address mapping module 81 corresponds to a L2 instruction block in the L2 cache 21 with four entries per row; each entry corresponds to a L2 cache sub-block. Each entry has a valid bit and stores the block number BN1X of the L1 cache block that contains the μOps converted from the instructions in the corresponding L2 cache sub-block. When the L2 tag 20 is accessed by the IP on the bus 19, it can use the set number (i.e. index) and the way number that is matched and the address of the sub-block to read out the entry in block address mapping module 81, put the valid signal of that entry on bus 16, and put its BN1X on bus 82. If the entry is valid, the storage unit 30 in the block offset mapping module 83 is read directly by the L1 cache block number BN1X on bus 82. The IP Offset on bus 51 is mapped to a L1 cache block offset BNY 57 in the manner shown in FIGS. 2 to 6, and a read width of 65 is produced. BN1X on bus 82 also selects a L1 cache block in L1 cache 24. It then selects a single or number of instructions according to BNY 57 and the read width 65. The selector 26, which is controlled by the bus 16, sends those instructions to the processor core 28 for execution. If the bus 16 shows that the entry is invalid, it is necessary to read the L2 sub-block corresponding to the invalid entry from the L2 cache 21. Translate the instruction by converter 12, and store the result to the L1 cache block designated by the cache replacement logic in the L1 cache 24; at the same time the bus 16 controls the selector 26 to select the [symbol] Ops translated by converter 12 directly for the execution of the processor core 28. And store the block number of that instruction block 15 BN1X into the invalid entry in the block address mapping module 81 and set the entry to be valid.

In this way, the L1 tag 22 can be omitted by simply sending the IP on the bus 19 to the L2 tag 20 to be matched. If the μOp corresponding to IP already exists in the L1 cache 24 (the entry addressed by IP address in the block address mapping block 81, i.e., the output of the bus 16 is valid), the cache system provides the processor core 28 directly with the μOps in the cache 24; If the corresponding μOp is not in the L1 cache 24, the cache system will immediately output the corresponding instructions from the L2 cache, start conversion, therefore the cost of a cache miss is reduced effectively. This cache organization can also be used for deeper memory hierarchies. Take the three-tier cache as an example. The instructions can be stored in L3 cache. The instruction converter is located between the L2 cache and the L3 cache. The μOps are stored in L2 cache and L1 cache; The IP address is sent to the L3 block address mapper after the L3 tag matches. The L3 block address mapper contains entries corresponding to each L3 cache sub-block. The entry contains the block number of its corresponding L2 cache block. The L3 block address mapper also contains entries corresponding to each L2 cache sub-block which contains the block number of its corresponding L1 cache block. The offset mapping module corresponds to the L1 cache, in which stores the corresponding relationship between the μOps in the L1 cache block and the corresponding instruction sub-blocks and it also stores the mapping logic. In this way, even if the L1 cache is missing, there is no need for a long-delayed instruction conversion. This cache organization method is essentially that there is a correspondence between cache blocks (sub-blocks) between different levels of the cache hierarchy. In the lowest level of the hierarchy, IP is mapped into corresponding higher level block address BNX, and in higher level, the in-block offset of IP is mapped into [symbol] Op block offset BNY to address in higher level cache. The embodiment of FIG. 7 also improves the logical unit in the address mapper 23 to become the block offset mapping module 83 and to be controlled by branch prediction 15 from the branch target buffer 27. The structure of the block offset mapping module 83 is shown in FIG. 8. Wherein the entries 31, 33, 34 in the storage unit 30 are the same as those of the embodiment of FIG. 6. The up and down conversion module 50, the subtractor 68, the read width generator 60, the shift module 61 and the priority encoder 61 have the same structures and functions with the modules in FIG. 6 which have the same numbers. FIG. 8 adds the selector 63, the register 66, and the controller 69, and the connection mode of the adder 67 is also different from FIG. 6. The selector 63 selects the BNY obtained by the up-conversion module 50 to map the entry point on the IP offset 51 or the output of the adder 67 as a L1 cache block offset 57 to send to the L1 cache 24. The L1 cache block offset 57 also controls the number of shift bits of the shifter 61 in the read width generator 60. The L1 cache block offset 57 is further stored in register 66. The adder 67 adds the read width 65 generated by the read width generator 60 to the output of the register 66 and sends the result to be an input of the selector 63. The controller 69 receives the input of the branch prediction 15 and also detects the output of the adder 67. When the branch prediction 15 is to execute the branch or when the output value of the adder 67 is greater than the capacity of the L1 cache block, that is, when the next address is a branch or a sequential entry point, the controller 69 controls the selector 63 to select the up-conversion module 50 to map the BNY output obtained by the IP Offset on the bus 51; under other conditions, 69 controls the selector 63 to select the output of the adder 67. The adder 67 adds the offset address in the L1 cache block to the read width, and the sum is the initial L1 cache address for the next read. Thus, in the case of a non-branch or non-sequential entry point, the block offset mapping module 83 automatically generates a L1 cache block offset address 57, which requires the IP address sent via bus 19 only at the entry points. This avoids the double mappings from BNY to Offset and from Offset back to BNY, when generating the next read start address in the embodiment of FIG. 6.

In the embodiment of FIG. 8, the output of the adder 67, that is, the start L1 cache block offset to be read the next time (equivalent to the output of the adder 67 in FIG. 6), is sent to the down-conversion module 50, mapped by the conversion module 50, and subtracted by the IP Offset on the bus 51 in the adder 68, and the difference 29 is sent to the processor core 28 for maintaining correct IP, as in the embodiment of FIG. 6. Since the interface between the caching system above the dashed line and the processor core 28 and the branch target buffer 27 below the dashed line and so on in the embodiment of FIG. 7 does not change, the caching system in the embodiment of FIG. 7 can replace the caching system in the existing processor, without having to make changes to the processor core and BTB in the existing processor. In the embodiment of FIG. 2, the lower layer memory in the cache system disclosed in the present invention can store not only the instructions, but also the data, and can be the unified cache.

The existing branch target buffer (BTB) is addressed by an IP address. The entry of BTB contains branch prediction, branch destination address, and/or branch target instruction, where the branch destination address is also recorded with an IP address. In the example of the entries in the branch target buffer 27 of the embodiments in FIG. 2 and FIG. 7 of the present invention, it is also possible to be recorded using the L1 cache address BN. When the branch address sent by processor 28 accesses the BTB 27 and hits, the address in BN format in the entry can be used directly to access a L1 instruction block in L1 cache 24 according to its block number BN1X, and directly set its BNY to the output end of the up-conversion module of the block offset mapping module 83, and the output is selected by selector 63 and put on the bus 57. At the same time the read width generator in the block offset mapping module 83 selects that part of the [symbol] Ops according to the read width 65 generated by the BNY and sends the [symbol] Ops to the processor core for execution. To fill in the entry in BTB 27, the branch target address on bus 19 is mapped into a BN format branch target by block address mapping module 81 and the block offset mapping module 83, and the BN format branch target is stored in the entry of BTB 27 pointed by the branch instruction address 47 generated by processor core. The branch destination address recorded in the branch target buffer entry can also be combined, in which the block address can be IP format, i.e. the higher bits of IP except offset (tag, index and L2 sub block index); or L2 block number (BN2X), including L2 way number, index and L2 sub-block index; or L1 block number BN1X format. These address formats are either mapped by the block address mapping module 81 or directly accessible to the L1 cache 24. The block offset address in it can either be IP offset which needs to be mapped to L1 cache block offset BNY by block index mapping module 83; or directly be BNY. The branch destination address in the branch target buffer 27 entry may be a combination of all the above block address formats and the block offset address formats. For more memory levels, the block address format can be obtained by analogy.

An entry that is recorded as an address in the branch target buffer 27 with BN1X or BN2X as an address may cause an error after the cache block replacement, that is, the L1 cache block pointed to by the branch destination address BN1X in the BTB record has been replaced and is no longer a branch target cache block. This problem can be solved with a Correlation Table (CT), and each row in the correlation table corresponds to a L1 cache block. There is a remapping entry in the row which stores the lower level cache block address (such as BN2X or IP block address), and the other entries store the BTB address of the BTB entry whose branch target is the cache block corresponding to that row (i.e. the address of the branch instruction). When a L1 cache block is created, its corresponding lower block address is recorded by the remapping entry of the corresponding row in the CT. When an entry whose branch target is that L1 cache block is recorded in the branch target buffer 27, the BTB address (branch instruction address) of that record is recorded in other entries in the CT corresponding to that L1 cache block. When an L1 cache block is replaced, checks the CT lines which corresponds to that block, and use the lower memory block address in the remapping entry to replace the L1 cache block address BN1X of the BTB entries recorded by the other entries.

Some small modification can be made to the processor core 28, the structure of the instruction converter 12, and the addressing mode for the branch target buffer 27 are so that the block offset mapping module 83 can be simplified to make the processor system more efficient. The correct IP maintenance of the processor core to has three meanings to the memory hierarchy: Firstly, it provides the next block offset address in the same memory (cache) block based on the exact block offset address; Secondly, it can provide the sequential next block address based on the exact block address; Thirdly, it can calculate the direct branch target address based on the exact block address and the exact block offset address. Here, the block address refers to the higher part of the IP address except the block offset address. As for the indirect branch instruction, it does not require accurate IP, because the calculation of the branch target address information (base address register number and branch offset) are already included in the instruction, without need of the command address information. The first meaning of the IP has been implemented by the block offset mapping module 83. If the requirements for the exact block offset address in the third meaning can be eliminated, then the system only needs to maintain accurate IP block address, and the exact L1 cache block offset BNY, to avoid the remapping from BNY to Offset.

The instruction converter 12 is slightly modified to achieve the above purpose. The instruction translation module 41 in the instruction converter 12 can add the block offset address of the instruction itself to the branch offset contained in the instruction when converting the direct branch instruction, and use the sum as the branch offset contained in the converted μOps. When the processor core executes the direct branch μOps that are modified by this method, it is possible to obtain an accurate branch target by adding the block address of the branch μOp to the modified branch offset in the μOp IP address. Thus, the need for an accurate instruction block offset IP Offset is eliminated. The processor core in this structure only needs to store the correct IP block address, so the down conversion module 50 and the subtractor 68 in the block offset mapping module 83 can be omitted. The processor core also maintains an adder that generates IP addresses for generating the indirect branch target address and the sequential next block address. When the processor core 28 executes indirect a branch μOp, the base address of the register heap is read according to the register heap address in the μOp, and added to the branch offset in the instruction to obtain the branch target address. The branch target address is sent via the bus 18. When the processor core 28 executes the direct branch μOp, the branch target address is obtained by adding the stored exact IP block address and the modified branch offset in the instruction, and is sent via bus 18. The controller 69 in the block offset mapping module 83 sends a change block signal to the processor core 28 when it is necessary to execute the next L1 cache block (when the output of the adder 67 exceeds the L1 cache block boundary). The processor core 28, under the control of that signal, causes its IP address adder to add ‘1’ at the lowest bit of the stored exact IP block address and set the block offset address IP offset to all ‘0’ and send it via bus 18. The controller 69 in the block offset mapping module 83, as described above, only causes the selector 63 to select the IP offset mapped by the up-conversion module 50, or select the value of entry 37 in FIG. 3 as the start block offset address 57 only in the above-described cases. The selector selects the output of the adder 67 as the starting block offset address 57 in other cases.

Since the processor core does not save the exact instruction block offset address, the addressing mode of the branch target buffer 27 should also be changed accordingly. The writing and reading of entries of the branch target buffer 27 can be addressed by using the IP block address and the μOp block offset address BNY. The exact BNY can be saved by the processor core, updated according to the read width 65 generated in the block offset mapping module 83, or updated at the entry point by the entry point BNY. When the processor checks the instruction and judges it to be a branch instruction, it will use the corresponding IP block address and the μOp block offset address BNY via the bus 47 to access the branch target buffer 27 to read the corresponding branch prediction value and the branch destination address or branch target instruction. It is also possible to read the branch μOp entry 34 in the storage unit 30 by the block offset mapping module 83 to determine the BNY address of the branch instruction, i.e. access the branch target buffer 27 via the bus 47 with the exact IP block address stored in the processor core. The IP block address can also be replaced with BN1X, BN2X address, etc., and be merged with BNY as the BTB address, if 15 guarantees to fill in and read the same format of BTB. The advantage of doing this is, for the BN1X block address is shorter than the IP block address, it will occupy less storage space. But the corresponding BN1X, BN2X block address of the corresponding IP address is not necessarily continuous, so every time after the IP block address updates, it needs to access the L2 tag 20 and the block address mapping module 81 via bus 19 to get the corresponding BN1X block address, etc. Only part of the IP addresses is saved in this architecture.

Further, two memory entries can be added for each L1 cache block to store the block address BN1X of the previous (P) and next (N) L1 cache blocks in the sequential order. The actual placement of the entry may be in a separate memory, either in the block offset mapping module 83, or in the CT, or even in the L1 cache 24. When the next instruction block is converted by the sequence enter point, the corresponding L1 cache block number BN1X is written to the N entry of the block and the BN1X of the block is written to the P table entry of the next L1 cache block. Thus, when the controller 69 in the block offset mapping module 83 in FIG. 8 prepares to change the instruction block, the N entry may be checked. If it is valid, the instructions in the L1 cache 24 can be read directly by the BN1X of the N entry and the BNY in entry 37 of the storage unit 30 of the block offset mapping module 83 and the read width generated by the BNY for execution of the processor core 28. If the N entry is invalid, the IP block address on the bus 19 is needed to be mapped to the BN1X address in the L2 tag 20 and the block address mapping module 81 as described above. The IP Offset of all ‘0’ is also mapped into BNY by the block offset mapping module 83 and generates a corresponding read width 65 for accessing the L1 cache 24. When the L1 cache block is replaced, the possible errors caused by cache replacement can be avoided, by finding the previous cache block according to its corresponding P entry content, and setting the N entry in it to be invalid.

A data structure named a track table can be used to replace BTB to further improve the processor system. The track table not only stores the branch instruction information, but also contains the information of the sequentially executed instructions. FIG. 9 shows an example of a cache system incorporating a track table according to the present invention. Wherein 70 is an embodiment of the track table of the present invention. The track table 70 consists of the same number of rows and columns as the L1 cache 24, where each row is a track corresponding to a L1 cache block in the L1 cache, and each entry on the track corresponds to a μOp in the L1 cache block. In this example, it is assumed that each L1 cache block (μOp block) in the L1 cache contains up to four μOps (the BNYs are 0, 1, 2, 3, respectively). Hereinafter, five μOp blocks (whose BN1X are ‘J’, ‘K’, ‘L’, ‘M’, ‘N’) in the L1 cache 24 are taken as an example. Therefore, there are 5 corresponding tracks in the track table 70, and up to four entries can be stored in each track, which corresponds to up to four μOps in the L1 cache block in 24. The entries in the track are also addressed by BNY. In this example, the track table 70 and the corresponding L1 cache 24 can be addressed by the tracking address BN1 composed of the block address (i.e., the track number) BN1X and the block offset address BNY, and it then reads the track table entries and the corresponding μOps. The fields 71, 72, and 73 in FIG. 9 are the entry formats of the track table 70. There are specialized fields to store program flow control information in the entry format of the track table. Wherein the field 71 is a μOp type format, and can be divided into two categories: non-branch and branch μOp according to the corresponding μOp type. The types of branch μOps can be further subdivided into direct and indirect branches according to one dimension, or they can be subdivided into conditional branches and unconditional branches according to another dimension. The field 72 stores the memory block address, and the field 73 stores the offset address in the memory block. In FIG. 9, the BN1X format is shown in field 72, and BNY format in field 73. The memory address may also use other formats and address format information may be added to the field 71 to illustrate the address formats in fields 72 and 73. Only one of the non-branch μOps track table entries stores the non-branch type μOps type field 71, while the branch [symbol] Op track table entry stores not only [symbol] Op type field 71, but also BNX field 72 and BNY field 73. Since it corresponds to the L1 cache 24, the track table 70 is filled from right to left beginning from the entry in the track table 70 where BNY is ‘3’. There are invalid entries in the low bits of BNY, which are expressed in shadows, such as K0 and M0.

Only the fields 72 and 73 are shown in the track table 70 of FIG. 9. For example, the value ‘J3’ in the entry ‘M2’ indicates that the branch target address of the μOp corresponding to the ‘M2’ entry is the L1 cache address ‘J3’. In this way, when the ‘M2’ entry in the track table 70 is read out according to the track table address (i.e., the L1 cache address), it is determined that the corresponding μOp is branch μOp according to the field 71. According to the fields 72, 73, it is known that the branch target of the μOp is the μOp of the ‘J3’ address in the L1 cache. The μOp of BNY ‘3’ in the ‘J’ μOp block in the L1 cache 24 found by addressing is the branch target μOp. In addition, in the track table 70, an additional end column 79 is included in addition to the above-mentioned BNY columns of ‘0’˜‘3’. Each end entry in the end column 79 only has fields 71 and 72, where field 71 stores an unconditional branch type, and field 72 stores BN1X of the next μOp block of the sequential address of the corresponding μOp block corresponding to the row. So the next μOp block can be found directly in the L1 cache according to the BN1X and the corresponding track of the next μOp block can be found in the track table 70. In this example, the end column 79 can be addressed with BNY ‘4’.

The blank entries in the track table 70 shows the corresponding non-branch μOps and the remaining entries correspond to the branch μOps. These entries also show the L1 cache address (BN) of the branch target (micro operation) of the corresponding branch μOp. For the non-branch μOp entry on the track, the next μOp to be executed can only be the μOp represented by the entry on the right of the same track; For the last entry in the track, the next μOp to be executed is only possible to be the first valid μOp in the L1 cache block pointed to by the content of the end entry on the track; For the branch μOp table entry on the track, the next μOp to be executed may be the μOp represented by the entry on the right side of the entry, or it may be the μOp pointed by the BN in the entry, and the selection is depends on the branch judgment. Thus, the track table 70 contains all the program control flow information for all the μOps stored in the L1 cache 24.

Please refer to FIG. 10, which is an embodiment of the track table based cache system of the present invention. This example includes a L1 cache 24, a processor core 28, a controller 87, and a track table 80 of the same way as the track table 70 in FIG. 9. An incrementor 84, a selector 85, and a register 86 form a tracer (in the dashed line). The processor core 28 controls the selector 85 in the tracer according to the branch judgment 91, and controls the register 96 in the tracer according to the pipeline stop signal 92. The selector 85 selects the output of the track table 80 or the output of the incrementor 84 by the control of the controller 87 and the branch judgment 91. The output of the selector 85 is registered by the register 86 and the output 88 of the register 86 is referred to as a read pointer with the instruction format BN1. Note that the data width of the incrementor 84 is equal to the width of the BNY and is only incremented by 1 for the BNY in the read pointer without affecting the value of BN1X therein. If the incremental result overflows the width of BNY (that is, the capacity of the L1 cache block, for example, when the carry output of incrementor 84 is ‘1’), the system will look for BN1X of the next L1 cache block sequentially to replace this block BN1X. The following examples are the same as this, and the explanation is not repeated. The system in the tracer accesses the track table 80 with the read pointer 88 and outputs the entry via the bus 89 and accesses the L1 cache 24 to read the corresponding μOp for the processor core 28 to execute. The controller 87 decodes the field 71 in the entry output by the bus 89. If the μOp type in the field 71 is non-branched, the controller 87 controls the selector 85 to select the output of the incrementor 84, at the next clock cycle the read pointer is incremented by ‘1’, and the sequential next (Fall Through) μOp is read from L1 cache 24. If the μOp type in the field 71 is branched, the controller 87 controls the selector 85 to select the field 72 and 73 on the bus 89, at the next clock cycle the read pointer is pointed to the branch target, and the branch target μOp is read from L1 cache 24. If the μOp type in field 71 is a direct conditional branch, the controller 87 controls the selector 85 using the branch judgment 91. If the judgment is non-branch, then at the next clock cycle the read pointer is increased by ‘1’, and the sequential next (Fall Through) μOp is read from L1 cache 24; If the judgment is branch, then at the next clock cycle the read pointer points to the branch target, and the branch [symbol] Op is read from L1 cache 24. When the pipeline is halted in the processor core 28, the update of the register 86 in the tracer is halted by the pipeline stop signal 92, causing the caching system to stop providing new μOps to the processor core 28.

Returning to FIG. 9, the non-branch entry in the track table 70 can be discarded to compress the track table. In addition to the original fields 71, 72, 73, the entry format for the compressed track table adds the source BNY (SBNY) field 75 to record the offset address in the (source) block of the branch μOp itself. Since the compressed entry has a horizontal displacement in the table, it is no longer able to address it directly with BNY, although it still maintains the order between the branch entries. In this example, the P field 75 is also added to the compressed track entry, which stores the branch prediction value to replace the value normally stored in the BTB. The compressed track table 74 stores the same control flow information in the track table 70 in the compressed table entry format. The track table 74 shows only the SBNY field 75, the BN1X field 72, and the BNY field 73. For example, the entry ‘1N2’ in the K row indicates that the entry represents the μOp with address K1, and the branch target is N2. The end track point shown in the track table 74 uses the same entry structure as the other entries. The value of the SBNY field 75 ‘4’ indicates that it is the end track point. Of course, the field 75 in the end track point may also be omitted, since the track point in the rightmost column of the track table 74 must be the end. Each time the sequential next entry block is entered from the L1 cache block, the value of the entry 37 in the memory unit 30 in the block offset mapping module 83 corresponding to the next cache block (at this case, it is the BNY value of the sequential entry point) is stored in the field 73 in the end track point of the present block. Thus, the next time when the cache block is entered sequentially, the L1 cache block can be selected according to the field 72 read out by the track table 74, and the start address is determined based on the read field 73, and the corresponding entries 37 and 32 of the cache block need not be detected. In the track table 74, the table entry and its corresponding μOp can be addressed by the value of the SBNY field 75 in the entry. When the read pointer 88 addresses to the track table 74, the value of SBNY in all the entries corresponding to the row is read out with the BN1X. And it also compares each of the SBNY values with BNY77 in the read pointer respectively in the comparator of the corresponding column (e.g., comparator 78, etc.). The comparator, if the SBNY value of this column is less than the BNY, outputs ‘0’, otherwise outputs ‘1’. Detect the outputs of these comparators and find the first ‘1’ from left to right, and output the entry content in the row that BN1X selects and the column that the first ‘1’ corresponds to. For example, when the addresses on the read pointer 88 are ‘M0’, ‘M1’, or ‘M2’, the outputs of the three comparators from left to right (78, etc.) are all ‘011’, so the entry contents corresponding the first ‘1’ are all ‘2J3’. However, when the address on the read pointer 88 is ‘M3’, the outputs of the comparators are ‘001’, so the outputs are the entry contents ‘4N0’.

The controller 87 also compares the BNY on the read pointer 88 with the SBNY on the track table output bus 89 when the compressed track table of the format 74 is used as its track table 80 in the embodiment of FIG. 10. If BNY is less than SBNY, the μOp corresponding to the track table entry accessed by the read pointer 88 is after the μOp of the same read pointer 88, and the system can continue to progress. If the BNY is equal to SBNY, the track table entry accessed by the read pointer 88 corresponds to the μOp that is accessed, and the controller 87 can control the selector 85 according to the branch type in the field 71 on 89 and/or the branch prediction in the field 76 to execute the branch operation. The caching systems in the embodiments of FIG. 9 and FIG. 10 both provide one μOp at each clock cycle, for the convenience of illustration.

FIG. 11 is an embodiment of a multi-read processor system using a compressed track table. In this example, the L2 tag unit 20, the block address mapping module 81, the L2 cache 21, the L1 cache 24, and the selector 26 are the same as those in the embodiment of FIG. 7. The processor core 98 is similar to the processor core 28, but it is capable of selecting can select a μOps identified by certain flag based on the branch decision, abort the execution the μOps marked by some flags, while execute the μOp marked by the other flags. Also, the processor core 98 does not need to maintain the IP address. The selector 85 and the register 86 of the tracer are the same as the function in FIG. 10, but the incrementor 84 in FIG. 10 is replaced by the adder 94 in this example to support instruction multiple read. The register 96 and the selector 97 are added to select the output of the register 86 or 96 as the read pointer 88. The track table 80 uses a compressed table of 74 format or other formats and contains logic for updating branch prediction value P of the field 76 according to the branch judgment. The selector 95 selects the addresses of the plurality of sources to the L2 tag 20. The instruction scan converter 102 replaces the instruction converter 12 in FIG. 7. In addition to all the functions of the instruction converter 12 described above, the instruction conversion scanner 102 can also scan and review the branch information of the converted instruction to generate the track table entry. The buffer 43 in 102 adds the capacity to temporarily store a track generated by 102. The track entry is formatted according to the compressed track table 74 in FIG. 9.

In the present embodiment, the L2 tag unit 20, the block address mapping module 81, and the L2 cache 21 correspond to each other. A same address can select the corresponding rows of the three, where the L2 cache 21 stores the instruction; The track table 80, the memory unit 30 in the block offset address mapper 93, the correlation table 104, and the L1 cache 24 correspond to each other and a same address can select the corresponding rows of the four. The address format in this example is shown in FIG. 12. The upper part is the memory address format IP, which is divided into tag 105, index 106, L2 sub-block address 107 and the block offset address 108, which is the same definition of the IP address in the embodiment of FIG. 7. The middle part of FIG. 12 is the L2 cache address format BN2, wherein the index 106, sub-block number 107, and block offset address 108 are identical to the fields with the same numbers in IP address. The field 109 is the way number. The L2 cache is a multi-way set associated organization, the corresponding L2 tag unit 20, the block address mapping module 81 and the L2 cache 21 all contain multi-way memory, addressing and read-write structure; each set (i.e. memory row in each way) is addressed by the index field 106 of the address. The rows in L2 tag unit 20 store the tag field 105 of IP address; each row of the L2 cache 21 contains a number of sub-blocks, and each row of the block address mapping module 81 contains a number of entries. The sub-blocks and entries are addressed by L2 sub-block address 107. The block address mapping module 81 entry has a L1 cache block address BN1X and a valid bit as the embodiment of FIG. 7. The way number 109, the index 106, and the sub-block number 107 are collectively referred to as BN2X, which points to an instruction sub-block, wherein the way number 109 selects the path, the index 106 selects the set, and the sub-block number 107 selects the sub-block. The L2 cache can access the entry in block address mapping module 81 and the instruction sub-block in L2 cache 21 directly by using the L2 cache sub-block address BN2X; or indirectly by using the index 106 of the instruction address to read the tag of the ways in the L2 tag unit 20 of the same set, and match the result with the tag field 105 of the instruction address to get the way number 109; and use the BN2X formed by the way number 109, index 106 and the sub-block number 107 to access the block address mapping module 81 and the L2 cache 21. Also, the above direct method can be used to read the tag of L2 tag unit 20 for the use of tag conversion scanner 102. The embodiment of FIG. 7 also uses the same L2 cache address format BN2, but can only be accessed indirectly via the IP address on the bus 19, so the BNX2 is not emphasized. The lower part of the FIG. 12 is the L1 cache address format, wherein the field 72 is the [symbol] Op block address BN1X, and the field 73 is the [symbol] Op block offset address BNY, which is the same as the embodiments of FIG. 7 and FIG. 9 and no further explanation is made here. The L1 cache uses full-associated organization structure.

Back to FIG. 11. The L1 cache 24 uses full-associated organization, and the replacement logic provides the system with the next L1 cache block number BN1X according to the replacement strategy. Assume that the processor core 98 is executing an indirect branch μOp and is judging the execution of the branch. The processor core 98 adds the base address in the register to the branch offset recorded in the μOp as the branch target memory address, and sends it via the bus 18, the selector 95, and the bus 19 to the L2 tag unit 20 to match. If it is not matched in the L2 tag unit 20, i.e. missing in L2 cache, the system will send the memory address on bus 19 to the lower level memory to read instructions and save them into L2 cache 21. The L2 cache replacement logic selects a way within the set specified by the index 106 in the bus 19 to store instructions from the lower layer memory. At the same time the tag 105 on bus 19 will is saved into the row with same way and same set of the L2 tag unit 20. If it is matched in L2 tag unit 20, then the BN2X is formed by the way number 109 obtained by the matching, the index 106 on bus 19, the sub-block number 107 and the BN2X is used to access the block address mapping module 81. If the entry read from the block address mapping module 81 is invalid, i.e. L1 cache missing, then it uses the block number BN1X of the replaceable L1 cache block to store in that entry, and set it to be valid after the instruction is translated into [symbol] Ops and saved in this cache block; and it uses the BN2X to address in the L2 cache 21, reads the corresponding L2 sub-block and send it to the address conversion scanner 102 via bus 40; and the memory address IP on bus 19 is also sent to scanner 102 via bus 101. The scanner 102 starts from the byte pointed by the offset field 108 of the IP address and translate the L2 instruction sub-block into [symbol] Ops and sent the result out via bus 46. At this time, the controller 87 controls the selector 26 to choose the [symbol] Op on bus 46 for the execution of the processor core 98. And the scanner decodes the operation code of the converted instruction. If the instruction is a branch instruction, the [symbol] Op type 71 is generated by the type of the branch instruction and a track entry is allocated for it and saved in the temporary track of buffer 43 from left to right according to the order of the instructions in the instruction block. The scanner 102 does not allocate an entry for the non-branch instruction, thereby achieving the compression of the track.

When the instruction type is a direct branch, the scanner 102 also adds the field 105, 106, 107 in the IP address sent via the bus 101 and the block IP offset of the branch instruction itself (i.e. the address of the branch instruction itself) to the branch offset described in the instruction, to calculate the branch target instruction address of that direct branch instruction. The branch target address is sent via the bus 103, the selector 95, and the bus 19 to the L2 tag unit 20 to match. If there is no match, it reads the instruction block which contains the branch target from the lower level memory and store it to L2 cache 21, and store the tag field 105 of the branch target address on bus 19 into L2 tag unit 20. If the tag is matched, the matched way number 109 and the fields 106, 107, 108 of the bus 19 form a L2 cache address BN2 and the BN2 is stored into buffer 43 of the scanner 102. The L2 cache block address BN2X formed by field 109,106,107 is stored in field 72, and the instruction block offset field 108 is stored into field 73. And the block offset address BNY corresponding to the μOp of the branch instruction is stored in the SBNY field 75. In this way, all the fields except the branch prediction field 76 in an entry of the track table, are generated with L2 tag 20 as the same time as the scanner 102 converts the instruction.

If the instruction type is indirect branch, the scanner 102 generates the μOp type field 71 and the SBNY field 75 for its corresponding track table entry, but does not calculate its branch target, and does not fill its fields 72 and 73. So that it converts and extracts to the last instruction of the instruction block. The scanner 102 calculates the L2 cache sub-block address BN2X of the next sequential sub-block by adding ‘1’ to the BN2X address of the sub-block. However, if this calculation results in a carry on the boundaries of fields 107 and 106 (or crossing the boundary of the L2 instruction block), it needs to add ‘1’ to the IP sub-block address (fields 105, 106, 107) to calculate the IP address of the next sequential sub-block, and sends it to the L2 tag unit 20 via the bus 103 to be matched into the BN2X address. If the last instruction extends to the next instruction sub-block, then the scanner 102 uses the BN2X address of the next sub-block described above to read the next sub-block from L2 cache 21 to convert the last instruction of this block completely, and extract the information to save in buffer 43. After that, it creates an end tracing point entry to the last (rightmost) existing entry of the temperate tracks in buffer 43, saves ‘4’ into the SBNY field 75, saves ‘non-conditional branch’ in the type field 71, saves the next block address BN2X described above into the block address field 72, and saves the starting byte address of the first instruction of the next instruction block into the block offset address field 73.

At the same time of the instruction conversion operation described above, the system addresses one row in the correlation table (CT) 104 using the block address BN1X of the replaceable L1 cache block described above, and uses the L2 cache block address BN2X stored in the remapping entry of it to replace the BN1X in the track of the track table 80 which is identified by the address stored in other entries in the row of CT 104. That is, replacing the branch path which points to the L1 cache block being replaced to pointing to its corresponding L2 branch sub-block. The system also invalidates the entry addressed by BN2X in the above-mentioned remapping entry in the block address mapping module 81 so that the replaced L1 cache block is disconnected from its original corresponding L2 branch sub-block; That is, all the mapping relationship with the replaced L1 cache block is removed, so that the replacement of the L1 cache block will not lead to tracking errors. And the system stores the L2 cache block address of the converted instruction sub-block in the remapping entry of that row in the CT 104 and invalidates the other entries of the row. After that, the [symbol] Op 35 temporarily stored in the buffer 43 in the instruction conversion scanner 102 is stored in L1 cache block pointed by the above-mentioned BN1X aligned by the highest bit; The track temporarily stored in the buffer 43 is also stored into the track in the track table 80 pointed by the BN1X, aligned by the highest bit; The table entries 31, 33 and so on stored in the buffer 43 are also stored into the row of the block offset address mapper 93 designated by the BN1X in the storage unit 30 as described in the embodiment of FIG. 3 and FIG. 4, and will not be described again. The low (left) part of the above entry 31, 33 that is not filled are filled with ‘0’; Any entries that are not filled on the left side of the track are marked as invalid, for example, the SBNY field 75 is marked as negative; The replacement of the track removes the mapping relationship targeting at the replaced L1 cache block.

The read pointer 88 of the output of the tracer addresses the L1 cache 24 to read the μOps for execution by the processor core 98 and also addresses the track table 80 via the bus 89 and reads out the entry (which corresponds to the instruction itself read from the L1 cache 24 or the first branch instruction after it). The controller 87 decodes the type field 71 of the bus 89. If the address type is L2 cache address BN2, the controller 87 then controls the selector 95 to select the address on bus 89, and directly addresses the block address mapping module 81 by the L2 cache block address in the BN2X of the BN2 via bus 19, and reads the entry via 82 without needing to match in the L2 tag unit 20. If the entry read from the bus 82 is ‘invalid’, it means that the L2 cache instruction sub-block addressed by the block number BN2X of that BN2 has not been converted to μOps and not stored into the L1 cache 24 At this time, the system uses the BN2X on bus 19 to address L2 tag unit 20, and reads out the corresponding tag 107, which, along with the index 106 on bus 19, the L2 sub-block number 107, and the block offset 108, is composed into a complete IP address. The IP address is sent to the instruction conversion scanner 102 via bus 101; and the system also uses that BN2X to address the L2 cache 21 to read out the corresponding L2 cache instruction sub-block and sends the result to scanner 102 via bus 40. The scanner 102 then converts (as described above) the instructions in the instruction block into μOps and sends them via the bus 46 and the selector 26 to the processor core 98 for execution; The scanner 102 also stores the μOps and the information obtained by the exaction, the calculation and the matching in the conversion process into the buffer 43. The L1 cache replacement logic provides a replaceable L1 cache block number BN1X After the instruction block conversion is complete, the scanner 102 stores (as described above) the μOps in the buffer 43 into the L1 cache block addressed by that BN1X in the L1 cache 24. The scanner 102 also stores the other information in the buffer 43 into the row in the storage unit 30 pointed to by the BN1X in the address offset mapper 93, and updates the row pointed to by the BN1X in the correlation table 104. The scanner 102 also stores the BN1X value in the block address mapping module 81 as described above and validates that entry value. Thereafter, when the entry in the block address mapping module 81, which is addressed by the BN2X output by the trace table 80 on bus 19, is ‘valid’, then the entry of the bus 82 is ‘valid’. The system then addresses the storage unit 30 in the block offset address mapper 93 by the BN1X on bus 82, and reads out the entries 31 and 33 in the row selected by that BN1X. According to the mapping relationship of entries 31 and 33, the offset address conversion module in the block offset address mapper 93 maps the block offset 108 on bus 19 into corresponding [symbol] Op offset BNY 73 and outputs it via bus 57. BN1X on bus 82 is merged with BNY on bus 57 to become a L1 cache address BN1. The system control replaces BN2 in the track table 80 entry with the BN1 and set the type field 71 format as BN1. The system may also bypass the BN1X directly to the bus 89 for the use by the controller 87 and the tracer.

The controller 87 controls the operation of the tracer according to the branch prediction 76 on the bus 89. There are two registers in the tracer to keep the branches of the branch μOp at the same time so that the branch can be returned when the prediction is wrong. The register 96 stores the address of the fall-through μOp of the branch μOp; the register 86 stores the address of the target μOp. The storage 30 in the block offset address mapper 93 will read the entries 31 and 33 via bus 82 when it needs to map the L2 cache address BN2 to L1 cache address BN1 as described above. At the other times, it reads the entry 33 addressed by the BN1X in read pointer 88 to provide the first condition (or the entry 33 can be designed to have duel read ports to avoid interfering each other). The number of μOps to be read can be controlled by reading the width of the second condition as described above with the contents of the entry 34; This number can also be obtained by subtracting the value of the read pointer 88 from the branch μOp address SBNY in the field 75 in the track table entry and adding ‘1’ to the result. If the result is less than or equal to the maximum read width, the result is the read width; if the result is greater than the maximum read width, the maximum read width is the read width. The present embodiment assumes that the read width is controlled by the second condition, i.e. the [symbol] Ops of and after the branch point read the block offset address BNY in read pointer 88 in different cycles and control the shifter 61 to shift the entry 33 as is shown in FIG. 8, and generate the read width 65 according to the first condition ( [symbol] Ops correspond to complete instruction) by priority encoder 63. If there is no requirement for the first condition, the read width 65 can be a fixed number of which amount the instructions can be read at a time. The read pointer 88 provides the L1 cache 24 with starting address, and the read width 65 provides the L1 cache 24 with the number of [symbol] Ops read in one cycle. The adder 94 adds the BNY value on read pointer 88 with the value of read width 65. The output of the adder 94 is used to be the new BNY and is combined with the BN1X value on read pointer 88 to be BN1, which is output by bus 99.

The controller 87 compares the BNY value on bus 99 with the SBNY value on the bus 89, and if the BNY is less than SBNY, the controller 87 controls the selector 90 to select the value on the bus 99 and saves it into the register 96; The controller 87 also controls the selector 85 to select the BN1 address (fields 72 and 73) on the bus 89 to be stored in the register 86 (or stores only if the value on the bus 89 changes). The controller 87 then controls the selector 97 to select the output of register 96 to be the next read pointer. If the BNY on the bus 99 is equal to SBNY on the bus 89, which means the branch μOp corresponding to the entry of the track table output via the bus 89 is read in this cycle then the controller 87 controls the system by the prediction value 76 on the bus 89. If the branch prediction value 76 is unbranched, the controller 87 controls the L1 cache 24 to transmit the μOps to the processor core 98 according to the read width 65. But according to the SBNY field 75 on bus 89, it sets the flag bits of the [symbol] Ops whose BNY addresses are greater than the branch point corresponding to that SBNY. Each μOp sent from the L1 cache 24 to the processor core 98 in the present embodiment has a flag bit. Refer to FIG. 13, where two horizontal bands with arrows represent two L1 cache blocks, where the execution order of μOps is from left to right. The [symbol] Op 111 in it is a branch μOp, and the μOp segment 112 is the fall-through [symbol] Ops of the branch operation; the [symbol] Op 113 is the branch target [symbol] Op, and the [symbol] Op segment 114 is the fall-through [symbol] Ops of the branch target operation. Return to FIG. 11, where the corresponding flag bits of each μOp of the μOp segment 11 are set to be speculate execute. The controller 87 now controls the selector 90 as described above to select the value on bus 99 and to save it in the register 96; the controller 87 controls the selector 97 to select the output of the register 96 as the next read pointer.

The adder 94 continues to add the BNY of the read pointer 88 and the read width 65. The sum together with the BN1X on read pointer 88 are sent via bus 99 and stored into register 96 as read pointer 88 for the next cycle, which controls 24 to send the corresponding μOps for the execution of processor core 98. The above process is repeated till a branch decision 91 is made and is sent to controller 87.

If the judgment is ‘do not execute branching’, the controller 87 controls the processor core 98 to retire the μOps that are flagged to be executed by prediction. The controller 87, also as the method described above, saves the output 99 of the adder 84 into register 96, controls the selector 97 to select the output of the register 96 to be the next read pointer. In this way, the loop between the adder 94 and the register 96 is proceeded. If the judgment is ‘execute branching’, then the controller 87 controls the processor core to abort the [symbol] Ops that are flagged to be executed by prediction. The controller 87 also controls the selector 97 to select the register 86 (at this time the content of it is the branch target from bus 89, that is, the address of the [symbol] Op 113 of the FIG. 13) to be the read pointer, addresses the L1 cache 24 to read the branch target and the fall-through [symbol] Ops (the number of which is determined by the read width 65 as described above). After that, the controller 87 combines the sum of the read pointer 88 and the read width 65, and the BN1X on the read pointer 99 into 99 and saves it into register 96. And it also controls the selector 97 to select the output of the register 96 to be the next read pointer and loop ahead like this.

If the branch prediction value 76 is ‘execute branching’, the controller 87 saves the BN1 address (i.e. the address of the first [symbol] Op of the [symbol] Op 111 of the FIG. 13) on bus 99 into register 96 to be the backtrack address when the prediction is wrong; the read width controlled by the second condition makes it only read the branch [symbol] Op 111 and the [symbol] Ops before it in FIG. 13. In the next clock cycle, the controller 87 controls the selector 97 to select the output of the register 86 to be the read pointer 88, and controls the L1 cache 24 to send the branch and fall-through [symbol] Ops (the [symbol] Op 113 and the [symbol] Op segment 114 in FIG. 13) to the processor core for execution, and set the flag bits of those [symbol] Ops as ‘speculate execution’. At the same time the controller 87 controls the selector 85 to select the output 99 of the adder 94 and saves it to register 86. At the next cycle, the controller 87 controls the selector 97 to select the output of the register 86 as the read pointer 88 to access the track table 80 and the L1 cache 24. The loop between the adder 94 and the register 86 is kept until the processor 98 executes the said sent [symbol] Ops and generates the branch judgment 91 to send to the controller 87.

In this embodiment, the end track point in the track is recorded as non-conditional branch type. When the BNY on the output 99 of the adder 94 is equal to or greater than SBNY in the field 75 on the bus 89, the controller 87 controls the L1 cache 24 to send the μOps, which begin at the address of the read pointer 88 and end at the last [symbol] Op of this L1 cache block, to the processor core 98 for execution. In the next cycle, the controller 87 controls the selector 97 to select the output of the register 86 to be the read pointer 88, and does not set the flag bits of the μOps sent in this cycle; stores the output 99 of the adder 94 into register 96; saves the BN1 address on bus 89 into register 86. In the cycle after next, the controller 87 controls the selector 97 to select the output of the register 96 to be the read pointer 88. In this way, the loop between the adder 94 and the register 96 continues to proceed.

When the controller 87 decodes the type field 71 on the bus 89 and judges the entry to be the indirect branch type, it controls the cache system to provide the processor 98 with μOps as described above until the [symbol] Op corresponding to the said indirect branch entry comes. The controller 87 then controls the cache system to suspend the μOps to the processor core 98. The processor core executes the indirect branch [symbol] Op and uses the register number of the [symbol] Op to read the base address in the register heap, and adds the base address and the branch offset in the [symbol] Op to get the branch target address. The IP of that branch target is sent to L2 tag 20 to be matched via bus 18, selector 95, and bus 19. The matching procedure and the operations are described above. The BN1 address obtained by the matching is bypassed to the bus 89. The controller 87 controls to save that BN1 into register 86. In the next cycle, it is executed according to the branch judgment 91 sent by the processor core 98, or according to the processor architecture (The indirect branch of some architectures is fixed to unconditional). The execution is the same as when the branch prediction is ‘speculate execution’ described above, but it does not need to set the flag bit of the [symbol] Ops, and does not need to wait for the branch judgment 91 generated by the processor core 98 to confirm the accuracy of the prediction.

The BN obtained by the IP address mapping of the said indirect branch target can be stored into the said indirect branch entry of the track table, and promote the instruction type of it to be the indirect-direct type. When the next time the controller 87 reads that entry, it treats it as direct branch type to be executed by the branch prediction method, i.e. set the flag bits of the [symbol] Ops as ‘speculate execution’. When the processor core executes that indirect branch [symbol] Op, it sends out the branch target IP address via bus 18. The address is mapped into BN1 address by L2 tag and so on as described above and the BN1 is compared with the BN1 output by the track table. If they are identical, then the controller retires all [symbol] Ops that are ‘speculate execution’ and continues to execute forward; if they are different, then all [symbol] Ops that are ‘speculate execution’ are aborted, and save the BN1 obtained by the IP address mapping into that indirect-direct entry in the track table and bypass it to bus 89. The controller 87 saves the BN1 into register 86, and controls the selector 97 to select the output of the register 86 to be the read pointer 88 to access L1 cache 24, and provides processor core 98 with the [symbol] Ops starting from the correct indirect branch target. It can also remap the BN1 in the indirect-direct entry into the corresponding IP address, and compare the IP address calculated by the processor core 98 and the remapped IP address while the processor core 98 is executing the indirect branch [symbol] Op. The remapping process is, read the entries 31 and 33 in storage unit 30 by the BN1X address in BN1, use the method of the down conversion module 50 like the embodiment of FIG. 8 to map the BNY of the BN1 address into the corresponding instruction block offset 108, and use the BN1X to read the BN2x address in the remapping entry of the CT 104, and use that BN2X to address the L2 tag 20 and read the tag. Combine the tag 105, the index 106 in the BN2X address, the sub-block number 107 and the instruction block offset 108, the memory address IP corresponding to the BN1 address above can be obtained.

FIG. 14 is another embodiment of the branch prediction value 76 stored in the track table 80 to control the buffer system to provide μOp to the processor core 98 for speculation execution. In FIG. 14, the functions and numbers of the functional blocks are identical with those in the embodiment of FIG. 11 except for the tracer. As compared with the embodiment of FIG. 11, the tracer of the embodiment of FIG. 14 removes the register 96 and the selector 97 of the embodiment of FIG. 11 are removed from, adds the selector 135, the first-in-first-out (FIFO) 136 and the selector 137; The output of the register 86 is directly the read pointer 88 in FIG. 14; And the control to the selector in the tracer is different from that in FIG. 11. In the present embodiment, the selector 135 and the selector 85 are directly controlled by the branch prediction field 76 on the bus 89. And the time of action, which is the same as the embodiments of FIG. 10 and FIG. 11, is when the controller 87 judges the BNY output by the adder 94 on bus 99 to be equal to the SBNY on bus 89. Each entry of the FIFO 136 stores a BN1 address and a branch prediction value; Inside the FIFO 136, the writeable entry is pointed by its inside write pointer, and the readout entry is pointed by the inside read pointer. The selector 137 is controlled after the comparison of the branch judgment 91 generated by the processor core 98 and the branch prediction value 76 stored in the FIFO 136. When the processor 98 does not generate branch judgment, the branch judgment 91 by default controls the selector 137 to select the output of the selector 85.

When the BNY on bus 99 is equal to the SBNY on bus 89, if the branch prediction value 76 on the bus 89 is ‘predict to branch’, then the selector 85 selects the branch target address BN1 on the bus 89 to store into register 86 to update the read pointer 88 to control the L1 cache 24 to send the branch target [symbol] Ops (113 of FIG. 13) and its fall-through [symbol] Ops (the [symbol] Ops on segment 114 of FIG. 13) for the execution of the processor 98. The said [symbol] Ops are flagged by one same new allocated flag value ‘1’; At the same time the address on the bus 99 (which is the [symbol] Ops that fall-through the branch [symbol] Op), the branch prediction value 76 on bus 89 and the new flag ‘1’ are saved into the entry pointed to by the write pointer in the FIFO 136. When the BNY on the bus 99 is equal to the SBNY on the bus 89, if the branch prediction value 76 on the bus 89 is ‘predict not branch’, then the selector 85 selects the fall-through [symbol] Op address on bus 99 to save into register 86 to update the read pointer 88 to control the L1 cache 24 to send the fall-through operations of the branch [symbol] Op to the processor 98 for execution. Those [symbol] Ops are also flagged by a same new allocated flag value; At the same time, the branch target [symbol] Op address on bus 89, the branch prediction value 76 on bus 89 and the new flag value are saved into the entry pointed by the write pointer in the FIFO 136. In short, the μOp addresses that are not selected by the branch prediction are stored in the FIFO 136 together with the corresponding branch prediction value and flag value. At the other time that the BNY on the bus 99 is not equal to the SBNY on the bus 89, the selector 85 selects the output 99 of the adder 94 to update the read pointer 88 to control the L1 cache 24 to send the fall-through [symbol] Ops to the processor core 98 for execution. These [symbol] Ops use the flag value that is allocated when the last time the BNY on the bus 99 equals to the SBNY on the bus 89.

When the processor core 98 generates the branch judgment, it reads out the entry in the FIFO 136 which is pointed to by the inside read pointer. The branch prediction 76 inside the entry is then compared with the branch judgment 91. If they are identical, that is, the branch prediction is right, then execute, write back and commit all of the μOps flagged by the flag value in the said entry read from FIFO 136 by processor core 98; and the comparison result controls the selector 137 to select the output of the selector 85, and makes the tracer continue updating the read pointer 88 according to its present status and send [symbol] Ops to processor core 98 for execution. Also, the inner read pointer of the FIFO 136 points to the fall-through entry.

If the comparison result is different, then the branch prediction is wrong, so the result controls the selector 137 to select the FIFO 136 to output the L1 cache address BN1 of the entry to save in the register 86, and uses the address of the path that is not selected by the branch prediction to update the pointer 88, and sends the [symbol] Ops to the processor core 98 for execution. All of the [symbol] Ops, which are flagged by the flag in the entry output by the FIFO 136 of the processor core and the following entries, are aborted. The method can be reading all the entries (from the read pointer to the write pointer) in FIFO 136 and aborting all the [symbol] Ops in the processor core that are flagged by the flags of the entries. After that, at the next branch point, according to the value on bus 89, which is selected by the selector 85 according to the branch prediction 76, to update the read pointer 88; and the flag value allocated to it, the path address that is not selected by the branch prediction 76, and the value of the branch prediction 76 are stored into FIFO 136. The above loop makes the processor core 98 execute [symbol] Ops according to the branch prediction value of the branch prediction 76. And when the processor core 98 generates the branch judgment 91, the branch judgment 91 is compared with the corresponding branch prediction 76 stored in the FIFO 136. If they are not identical, then abort the execution of the operations that are predict to be executed, and return to the path that is not selected by the branch prediction. The other operations in the embodiment of FIG. 14 are the same as those of FIG. 11, and will not be described again.

A L1 cache with dual port, which can be addressed by the fall-through (FT) address of the branch [symbol] Op and the branch target (TG) provided by the tracer and the track table simultaneously, can provide the processor core with the fall-through [symbol] Ops tagged by FT and the branch target [symbol] Ops tagged by TG simultaneously for the execution. After the processor gives the judgment of the branch [symbol] Op, it can selectively give up one set of [symbol] Ops in the FT and TG according to the judgment, and select the address of the other set to continue execution by the tracer addressing the track table and the L1 cache. Since the sequential μOp is mostly in the same L1 cache block, the same function of the duel port L1 cache can be implemented by an instruction read buffer (IRB) that can store at least one L1 cache block to replace one of the read ports of L1 cache to provide the FT μOps, and a single port L1 cache to provide the TG [symbol] Ops.

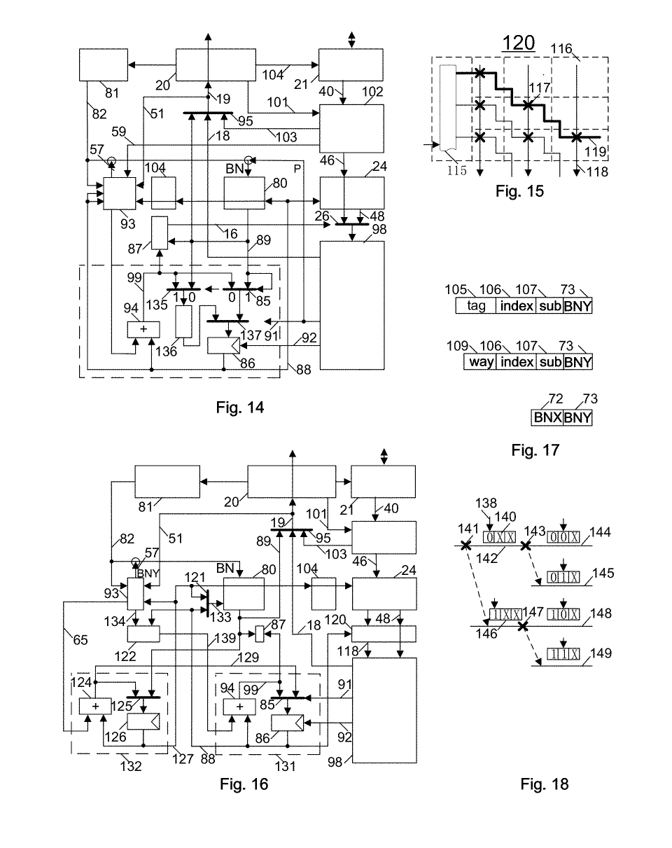

The instruction read buffer 120 in FIG. 15 is an IRB that supports multiple μOps per cycle to the processor core, with multiple rows (such as row 116, etc.), each row storing a μOp and placed from top to bottom in ascending order of the L1 cache block offset address BNY. The L1 cache can output a complete L1 cache block, and stores all μOps in the IRB. Each line of the IRB has a number of read ports 117 etc., which are represented in the figure by crosses. Each read port connects to a set of bit line 118 etc. The figure shows three read ports and three sets of bit lines in each row; each set of bit lines will send the read out μOps to the processor core. The decoder 115 decodes the block offset address BNY of the read pointer and selects a jagged word line (word line 119 for example), which makes the sequential three μOps to be sent via the bit line 118 and so on to the processor core for execution. Count the read width 65 flag start from the left, the bit line groups within the read width are valid, the bit line groups outside the read width is invalid, and the processor core only accepts and executes the valid bit line groups. A new BNY is obtained by adding the block offset address BNY to the read width 65 as described above. In the next cycle, the new BNY is decoded by the decoder 115 to select another jagged word line, which controls the read port of the word line to provide new μOps to the processor core. The difference between the start addresses of the two jagged word lines in the two cycles is the read width of the previous cycle. The L1 cache 24 can be implemented by the similar method. After the L1 cache block is read from the memory array, it uses the same decoder 115, word line 119, read port 117 and bit line 118 structure to select a number of consecutive μOps in each cycle and sends them to the processor core for execution. The difference is that 24 does not need the memory row 116 in instruction read buffer 120 and so on. FIG. 16 is an embodiment of a multi-issue processor system using IRB and L1 cache to provide the processor core with [symbol] Ops of both branches of a branch at the same time. In this embodiment, the L2 tag unit 20, the block address mapping module 81, the L2 cache 21, the instruction conversion scanner 102, the block offset address mapper 93, the correlation table 104, the track table 80, the L1 cache 24 and the processor core 98 are identical to the embodiment of FIG. 11. For the convenience of explanation, the selector 26 is not shown in the figure. The instruction read buffer IRB 120 is shown in FIG. 15. The block offset row 122 is added, which contains the read with generator 60 and stores the value of the storage 30 in the block offset mapper 93 sent from the bus 134, and the entry 33 in the corresponding row to the L1 cache block stored in the IRB 120. There are two tracers in this embodiment, wherein the target tracer 132 consists of adder 124, selector 125 and register 126, and generates the read pointer 127 to address L1 cache 24, CT 104 and block offset address mapper 93; wherein the block offset address mapper 93 provides the target tracer 132 with the read width 65 according to the read 127 as described above. The present tracer 131 consists of adder 94, selector 123, and register 86. The selector 85 accepts the bus 99 of the adder 94, and the bus 129 of the adder 124 in target tracer 132. The present tracer generates the read pointer 88 to address the IRB 120 and the block offset row 122. Wherein the block offset row 122 provides the tracer 131 with the read width 139 according to the read pointer 88. The controller 87, as described above, decodes the [symbol] Op type of the output 89 of the track table 80 to control the operation of the cache system, and compares the SBNY on the bus 89 and the BNY on bus 99 to obtain the branch operation time point. The selector 121, under the control of the controller 87, selects the read pointer 88 or the pointer 127 to be the address 133 to address the track table 80, with the default selection of pointer 88. The processing of the indirect branch μOp is the same as that of the embodiment of FIG. 11. When the controller 87 decodes the indirect branch type on the bus 89, it waits for the processor core 98 to generate the branch target address and to send it via bus 18. The branch target address is matched in L2 tag unit 20 via selector 95 and bus 19, and is mapped into BN2 or BN1 address and stored into track table 80. If the address format of the output 89 of the track table 80 is BN2, then send the BN2 address via selector 95 to the block address mapping module 81 to map it into BN1 address as described in the embodiment of FIG. 11, and the details are omitted here. The read width generation and so on is the same as that in the embodiment of FIG. 11, and in this embodiment these details are omitted for the convenience of understanding. In all embodiments of the present invention, for the convenience of explanation, it is assumed that the delay of the instruction read buffer is ‘0’, that is, the read buffer can be read out at the same cycle that it is written in.

The instructions are stored into L2 cache 21, and the address tags are stored into L2 tag unit 20. The instructions are translated into [symbol] Ops and stored into L1 cache 24. The control flow information in the instruction is extracted and stored into track table 80. The block address mapping module 81, the block offset address mapper 93 and the CT 104 have the same operations and procedures with the embodiment of FIG. 11, and the details are not described here. The L1 cache block, which contains the executing [symbol] Op in the processor core 98, is stored into IRB 120, and is addressed by the BNY in read pointer 88 each cycle. The obtained plural [symbol] Ops allowed by the maximum read width is sent to the processor core 98 via bus 118; And the read width generator in the block offset row 122, according to the information in its entry 33 and the BNY on read pointer 88, generates the read width 139 to mark the valid [symbol] Ops. The processor core 98 omits the invalid [symbol] Ops. The read pointer 88 also addresses the track table 80 via the selector 121 and read the entry via the bus 89. At each cycle, the controller 87 can compare the SBNY on bus 89 with the SBNY stored last cycle in the controller 87. If they are not identical, it indicates that the value on bus 89 changed, so it stores the SBNY on bus 89 into controller 87 each cycle for the comparison next cycle. When the controller 87 finds out a change on the bus 89, it controls the selector 125 in the target tracer to select the branch target BN1 on bus 89 to store in the register 126 to update the read pointer 127. The BN1X of the read pointer addresses the L1 cache 24 to provide branch [symbol] Ops to the processor core 98 via bus 48. The BN1X of the read pointer also addresses and reads the entry 33 of the corresponding row in the storage unit 30 of the block offset address mapper 93. The read width generator in the block offset address mapper 93, according to the information in the entry 33 and the BNY on the read pointer 127 to generate read width 65 to mark the valid [symbol] Op. These valid [symbol] Ops are marked as branch target ‘TG’. On the other hand, the controller 87 also compares the SBNY on the bus 89 and the BNY on the bus 99. If the BNY is greater than SBNY, the controller 87 marks all the [symbol] Ops that the IRB 120 sent to the processor core 98 whose block offset addresses are greater than SBNY to be ‘FT’, which means to be executed at the ‘fall-through’ circumstance.

If the controller 87 decodes the field 71 of the bus 89 to be a conditional branch, then it waits for the processor 98 to generate branch judgment 91 to control the program flow. Before the branch judgment is made, the selector 85 in the present tracer 131 selects the output 99 of the adder 94 to store in the register 86 to update the read pointer 88, and controls the IRB 120 continue providing the processor core 98 with ‘FT’ instructions until the next branch point; The selector 125 in the target tracer 132 selects the output 129 of the adder 124 to store into the register 126 to update the read pointer 127, and continues providing the processor 98 with ‘TG’ instructions until the next branch point. The processor 98 executes the branch [symbol] Ops to obtain the branch judgment 91. If the branch judgment 91 is ‘not branch’, the processor 98 aborts all the [symbol] Ops that are marked as ‘TG’. The branch judgment 91 also controls the selector 85 to select the output 99 of the adder 94 to store into the register 86, and makes BNY in the read pointer 88 continue to point to the fall-through [symbol] Op of the said ‘FT’ [symbol] Ops in the IRB 120. The block offset row 122 calculates the corresponding read width according to this BNY to set the valid [symbol] Ops to send to the processor core 98 for execution. The read pointer 88 addresses the track table 80 via the selector 121, and reads the entry through the bus 89. When the controller 87 finds out a change on the bus 89, it makes the selector 125 to select the BN1 on bus 89 to store into register 126, and makes the read pointer to address L1 cache 24, and sets the valid instructions by the read width 65, and marks the new branch target [symbol] Ops as ‘TG’ and sent them to the processor 98 for execution as described above.

When the branch judgment 91 is ‘branch’, the processor 98 abort the execution of all the [symbol] Ops with ‘FT’ flag. The branch judgment 91 also controls the selector 85 in the present tracer 131 to select output 129 of the adder 124 in the target tracer 132 to store into the register 86 to update the read pointer 88, and saves the L1 cache block addressed by the read pointer 127 at this time in the L1 cache to store into IRB 120; and stores the entry 33, which is addressed by the pointer 127 in the storage unit 30 of the block offset mapper 93, into the block offset row 122. The BNY of the read pointer 88 is pointing to the [symbol] Ops that follows the said ‘TG’ [symbol] Ops that are just stored into the IRB 120. The block offset row 122, according to that BNY, calculates the corresponding read width to set the valid [symbol] Ops to send to the processor core 98 for execution. The read pointer 88 also addresses the tracer 80 via the selector 121, and read the first branch target from the original branch target track corresponding to the L1 cache block that is just stored into IRB 120. The first branch target is stored by the controller 87 into the register 126 of the target tracer and is used to update the read pointer 127. The read pointer 127 addresses the L1 cache 24, marks the [symbol] Ops that are corresponding to the original branch target as ‘TG’, and sends them to the processor core 98 for execution. If the controller 87 decodes the type on bus 89 and judges is to be non-conditional branch, then controller 87 detects the BNY value on bus 99. If it is equal to the SBNY on bus 89, set the branch judgment 91 to be ‘branch’ directly. Then the processor 98 and the cache system execute as the circumstance that the branch judgment 91 is ‘branch’ as described above and the procedure is the same. There is an optimization that it can directly set the fall-through [symbol] Ops of the branch [symbol] Ops to be invalid rather than ‘FT’, so that the processor core 98 can utilize the resources more efficiently.

When all of the branch μOps in IRB 120 have been sent to processor core 98 for execution, the end track entry entries for the corresponding tracks are output by the track 89 via bus 89. The controller 87 detects the change on the bus 89, and controls the selector 125 to select the bus 89 and stores the next L1 cache block address BN1 in the end track point on bus 89 into the register 126 to update the read pointer 127. The subsequent operations are similar to those described above for the unconditional branch. i.e., the read pointer 88 addresses the IRB 120 to send out the [symbol] Ops, and the IRB 120 automatically marks the output word lines that exceed the L1 cache capability to be invalid. The read pointer 127 addresses the L1 cache 24 to send out the [symbol] Ops marked by ‘TG’ to the processor core 98 for execution. Therefore, the [symbol] Ops before the end track point on IRB 120 and the [symbol] Ops in the next fall-through L1 cache block are sent to the processor 98 for execution. The controller 87 detects the BNY value on bus 99. If it is equal to the SBNY on the bus 89, it indicates that the last [symbol] Op in IRB 120 in this clock cycle has already been sent to the processor core 98 for execution. If the controller 87 decodes the type on bus 89 and detects it to be unconditional branch, it set the branch judgment 91 to be ‘branch’ directly. At this time, the controller 87 controls the selector 85 in the present tracer 131 to select the output 129 of the adder 124 of the target tracer 132 to store into the register 86 to update the read pointer 88, and controls to store the L1 cache block addressed by the read pointer 127 in the L1 cache 24 into the IRB 120; and stores the entry 33 addressed by the read pointer 127 in the storage unit 30 of block offset address mapper 93 into the block offset row 122. The BNY of the read pointer 88 points to the [symbol] Ops after the said ‘TG’ [symbol] Ops in the IRB 120. The block offset row 122 also calculates the corresponding read width according to the BNY to set the valid [symbol] Ops to be sent to processor core 98 for execution.

When the BNY value on the bus 129 output from the adder 124 in the target tracer 132 exceeds the capacity of the L1 cache block (hereinafter referred to as overflow), it indicates that in the next clock cycle it should send the μOps in the fall-through cache block of the present branch target L1 cache block pointed by the current read pointer 127 to the processor core 98 for execution. When the controller 87 judges that this BNY overflows, the control selector 121 selects the read pointer 127 (at this time it points to the end track point) as the address 133 to address the track table 80, and sends the next block address BN1 of the end track point via the bus 89. The controller 87 further controls the selector 125 of 132 to select bus 89, and then stores this BN1 into the register 126 to update the read pointer 127. The cache system also provides the processor core 98 with μOp of the next sequential cache block that obtained by the updated read pointer 127 addressing the L1 cache 24. The block offset address mapper 93 also reads the corresponding entry 33 in the storage unit 30 in the BNX of the updated read pointer 127, and generates a read width 65 according to the BNY of the read pointer 127 to set valid μOps. The read width 65 and the BNY of read pointer 127 are added by the adder 124 to generate the BNY on bus 129 to for further use.

The track table can provide a branch μOp (or instruction) address (as shown in FIG. 16, the reading pointer 88), and its branch target μOp address (as shown in FIG. 16, the track table output 89) at the same time. These two addresses can be used to address a dual port μOp (instruction) memory, providing two μOp streams to the processor core. The processor core performs a branch μOp to generate a branch judgment to determine to continue execution of a μOp stream while discarding another stream; and selecting one of the two addresses according to the branch judgment for the following operations. There are a number of implementation methods based on this method. In the embodiment of FIG. 16, two tracers are used and each is responsible for the address of one stream. When the branch judgment has not yet been made, the adders 94 and 124 of the tracers 131 and 132 can continuously update their read pointers to continuously provide μOps to the processor core. Sometimes when a branch judgment has not been made, the fall-through branch μOp may have been read. At this time, the μOp after the subsequent branch μOp can be set to invalid, so that the tracer would stop updating its read pointer and wait for the branch judgment. The address of the branch μOp can be obtained, as described above, by SBNY in the output of the track table or using entry 34 as the second condition.

Although the present invention using processor system that executes variable-length instructions as examples a, the cache system and processor system of this discloser can be applied to the processor system that executes fixed-length instructions. In this case, the lower portion of the memory address (IP Offset) of the fixed-length instruction can be directly used as the block offset address BNY of the cache, and the block offset address mapping is not required. In this case, the (IP Offset of the address of the processor system that executes the fixed-length instruction is named BNY to distinguish it from the variable-length instruction address. The address format of the processor system that executes the fixed-length instruction is shown in FIG. 17, where the top is the memory address format IP, the middle is the L2 cache address format BN2 and the bottom is the L1 cache format BN1. The format is similar to the format which is used in the variable-length instruction processor system in FIG. 12. On the top, the tag 105, the index 106, and the L2 sub-block address 107 are the same as that of the embodiment of FIG. 12 except that the IP Offset 108 in the in FIG. 12 is replaced by the L1 cache block offset address BNY 73. In the middle is the level 2 cache address format BN2, where he index 106 of, sub-block number 107 and way number 109 are the same as in FIG. 12, but the block offset address 108 is also replaced by the L1 cache block offset address BNY 73. The bottom one is the L1 cache format BN1, which is the same as the embodiment of FIG. 12. A processor system that executes a fixed-length instruction can apply any of the cache or processor systems published in the present invention, which do not require the address mapper 23 or the block offset mapping module 83 or the block offset address mapper 93, and the lower BNY in fixed-length instruction address can directly address the L1 cache 24 without mapping. In addition, it is not necessary to determine the reading width 65 according to the first condition, so that the maximum reading width or the width generated according to the second condition may be used by the tracer to step on. It is also not necessary to use the logic 43 and 45 in the instruction convertor to generate the entry 31, 33, 34 etc. to store into the address mapper 23 or the block offset mapping module 83 or in the block offset address mapper 93. The L1 cache can also be replaced by a normal memory aligned by 2ⁿ address boundary without needing right alignment. The processor system that executes the fixed-length instruction can store instructions directly in the L1 cache 24; it can also convert the fixed-length instruction to μOps which are more convenient to execute and store them in the L1 cache 24. But the converted μOp addresses and the block offset addresses of the original instruction are not corresponded one-to-one, and the mapping is not required. The fixed-length instruction conversion can also start from any instruction, without needing to find the starting point of the instructions as the conversion of the variable-length instructions. Although the embodiments that this patent will describe later use the processor system switch executes variable-length instruction as examples, they all can be converted into fixed-length instruction processor system using the above method. Further description is not provided here.

The method described in FIG. 16 can be further improved to enable the cache system to provide μOps for processor cores with longer branch delays. In FIG. 18, the horizontal solid line represents μOp segment, which is from left to right based on the order of procedure; the slanting dashed line represents branch jumps; X stands for branch μOp. This specification defines each μOp segment, which starts from a μOp followed by a branch μOp, and ends up to the next branch of μOp (including). A processor with a long branch delay may require that the cache system provide 144,145,148,149 segments of μOps for continuous execution when the branch μOp 141 has not yet made a branch decision. Therefore, it is required to have an identification system that can identify each μOp segment as shown in FIG. 18, so that the processor core can choose to give up some μOp segments based on branch decision results. This specification contains a flag system with Branch Hierarchy and branch attributes (whether branch or not of the branch [symbol] Op before the [symbol] Op segment), so that branch decision can abandon executing the unselected μOp segments based on branch Hierarchy. This flag system dispatches a flag for each μOp segment, which flag represents the branch hierarchy of the segment and the branch attribute of the segment (this segment is the branch target μOp segment of previous instruction segment, or the fall-through μOp segment of non-branching); in the flag system, the branch decision produced by the processor core after executing the branch instruction is also expressed according to the branch Hierarchy and branch attribute of the flag system; therefore, this results in the speculate executed [symbol] Op segments not selected by branch decision are abandoned as early as possible, and ensures the speculated executed μOp segments selected by branch decision be normally executed and committed. This flag system can ensure the correct commitment order of disorderly dispatched μOp segment based on the hierarchical information in the flag, while the μOp order within the μOp segment is guaranteed by the order of μOps in the μOp segment. A kind of Hierarchical Branch Label System is shown in FIG. 18, which endows each μOp segment a flag to record the branch hierarchy and branch attributes of this segment.

In this flag system, the write pointer 138 attached to each μOp segment means the branch hierarchy of this μOp segment, the flag 140 attached in the μOp segment stores the branch attribute of this μOp segment in the pointed location of flag 138. The processor core produces branch decision (i.e., branch attributes) and a flag reading pointer to indicate the branch hierarchy of the branch to which 91 belongs, to make flag comparison with each μOp segment. Further, the flag system also expresses the branch history of the corresponding μOp segment (the position in the branch tree, which is expressed by the bit of the flag 140 between flag write pointer produced by the flag 138 and the flag read pointer produced by the processor core in this μOp segment), so when the execution of one fork of the branch is aborted, the execution of the children and grandchildren instruction segments of the fork are also aborted, which can release the ROB entries, reservation station, scheduler or execution units or other resources occupied by these μOps as soon as possible. The flag system has a history window (i.e. the bit number of the flag 140), which window length is greater than all outstanding segments in the processor, so as not to produce flag aliasing.

Wherein the flag 140 is the flag, whose format contains 3 binary bits. Among them, the entry (bit) in the left represents a level of branch, the middle digit means the daughter branch in next level, and the digit in the right represents the granddaughter branch of the next-next level. The value of each bit is the branch attribute of this μOp segment, where “0” means that the μOp segment is the fall-through μOp segment of its previous branch μOps, “1” means that the μOp segment is the branch target μOp segment of its previous branch μOps. The flag read pointer 138 represents the branch level of its μOp segment, and the bit pointed by the 138 stores the branch attribute of its μOp segment. The value which represents the branch attribute of the μOp segment is written to the bit pointed to by the flag read pointer 138, without affecting other bits.

For example, μOp segment 142 is the fall-through segment of μOp segment 141, the value of whose attached flag 140 is ‘0xx’, wherein ‘x’ means the original value, and its flag write pointer 138 points to the left bit. Correspondingly, the μOp segment 146 is the branch target segment of branch μOp 141, the value of its attached flag is ‘1xx’, and the flag write pointer also points to the left bit. When all operations (including branch μOp 143) in μOp segment 142 are sent out by cache system using ‘0xx’ flag, the fall-through segment 144 of μOp segment 143 and branch target segment 145 are also sent out. The way of flag system to generate new flag for the μOp segment is to inherit the μOp segment flag of the last level (namely the parent branch before a branch) to move the flag write pointer right by a bit (the branch hierarchy reduces one level), and write in the branch attribute in the bit the hierarchical pointer points to. Therefore, the flag inherited from the μOp segment 142 is ‘0xx’, and now the flag write pointer points to the middle bit; and the flag of the fall-through segment 144 of branch μOp 143 should be ‘00x’ according to the rules, and the flag of branch target segment 145 should be ‘01x’ according to rules. In the same manner, the flag of fall-trough 148 of branch μOp 147 shall be ‘10x’ based on rules, and the flag of branch target segment 149 is ‘11x’. Each operation segment sent by cache system all comes with the flag to the μOp segment which it belongs to. There is a flag read pointer in the processor core, and each time the processor core produces a branch decision, it will compare that branch decision with the bit pointed by the read pointer in flag 140 in the [symbol] Ops being executed in the processor core to abort the execution of part of the μOps, then, the read pointer of this flag moves to the right by one bit.

Assume that the processor core executes branch μOp 141, and gets branch decision ‘1’, which means the branch is taken at this point, according to the execution order, the flag read pointer generated by the processor points to the left bit of the flags in FIG. 18. This branch decision is compared with the left bit pointed by the flag read pointer of the attached flag in all μOps. The μOps that not correspond to branch decision in the left bit of this flag, that is, the μOp segments 142, 144 whose corresponding flag are ‘0xx’, ‘00x’ and ‘01x’, and all μOps in 145 are abandoned to execute. While the branch targets and subsequent μOps of branch μOp 141, that is, the μOps in the μOp segments 146, 148, and 149 with corresponding flags ‘1xx’, ‘10x’ and ‘11x’ are continuously executed by the microprocessor core. At this point, the cache system also judges according to the branch, in the same way, the address pointer of μOp segment that does not confirm to the branch decision in its flag bit can be aborted. That is, the address pointer of μOp segment 144, 145, are changed to be used to obtain the fall-through μOps of the retained μOp segments 148 and 149. Increment by the read width can be made to the address pointer which points to μOp segment 148, during the process, address the L1 cache to provide μOps to the processor core, and the address read pointer will naturally point to the fall-through μOp segment of the next branch μOp in μOp segment 148; at this time, because the read pointer has crossed the branch μOp, the flag write pointer moves to the right by one bit, and points to the right bit of the flag, so as to write the branch attribute ‘0’ of this μOp segment in the right bit; therefore, the flag of this segment is “100” by the rule, which is sent to the processor core along with the μOp. The address pointer that originally pointed to the μOp segment 144 can be made to point to the branch target μOp segment of next branch μOp in μOp segment 148, and its flag is “101” by rule. The flag is executed by the processor together with the μOp read by address read pointer. Similarly, the address read pointer that originally points to the μOp segment 149 now points to the fall-through μOp segment of the next branch μOp of μOp segment 149, the flag of which segment is ‘110’; and the address read pointer originally points to the μOp segment 145 now points to the branch target μOp segment of the next branch μOp of μOp segment 149, the flag of which segment is ‘111’; μOps read from the cache by address read pointer are sent with corresponding flags to processor core for execution.

The processor core continues to execute those μOp segments 146, 148, and 149 which are retained by branch decision of μOp 141. At this point, the flag read pointer moves to the right in a bit based on rules, and points to the middle bit of each flag. The processor core executes the μOp segment 147 to gain branch decision ‘0’, which indicates not branching. This branch decision is compared with the middle bits pointed to by the pointer of flags attached to all μOp segments. Inconsistent μOps with branch decision in the middle bit of the flag, that is, all μOps of μOp segment 149 and its following μOp segments, whose corresponding flags are ‘11x’, ‘110’ and ‘111’, are aborted to be executed. And all μOps of μOp segment 149 and its following μOp segments, whose corresponding flags are ‘0x’, ‘100’, and ‘101’, are continuously executed by microprocessor core. Then the cache system will make the address read pointer point to sequential new μOp segments of following μOp segments of μOp segment 148, and generates branch hierarchy flags for them. At this point, the write pointer of each flag points to the left bit of the flag, and branch attributes of each new μOp segment are written to the left bit of the flag. At this point, because the processor core has already executed the comparison of the branch decision to the original left bit of flag, and the μOp has been continued according to the left bit, and the information of the original left bit are no longer useful, therefore, the multiplexing of the branch attribute of new μOp segment stored in the left bit will not cause errors. Flag 140 may be viewed as a circular buffer. It is safe if the branch hierarchy depth of μOps a processor core may simultaneously processing is less than the branch hierarchy depth represented by the flag (in this case, it is the number flag bits). The resulting flag, as well as the μOp, are sent to the processor core for execution as described above. After executing a branch μOp, the processor core also moves the flag read pointer to the right in a bit, to point to the flag right bit to prepare to compare with judgment results of next branch. By repeating the above, the cache system can continuously provide μOps of all possible execution paths to the processor core without branch penalty or m is-prediction penalty, while the branch decisions are unknown.

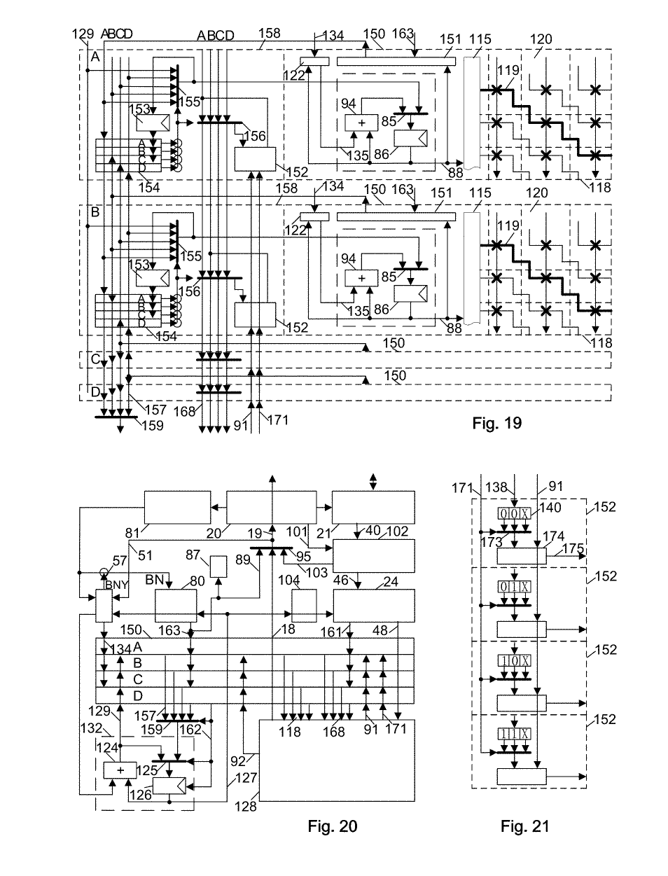

FIG. 19 is an embodiment that implements the hierarchical branch flags system and the address pointer in FIG. 18. Wherein the instruction read buffer 150 is a read buffer with hierarchical branch flag system and address pointer. The instruction read buffer 150 from right to left consists of the instruction read buffer 120, the tracker comprising the selector 85, the register 86, and the adder 94 which provides the address read pointer 88 to address the track row 151 and the decoder 115, the block offset row 122, and the issue scheduler 158 comprising the flag unit, the register 153, plural comparators 154, and the selector 155, 156, etc. There is a L1 cache block in the instruction read buffer 120, and the track row 151 has its corresponding track from the track table 80; in the block offset line 122, as illustrated in the embodiment of FIG. 16, there is a read width generator 60, as well as the entry 33 corresponding to the cache block in the instruction read buffer 120; the register 153 stores the L1 cache block address BN1X of the cache block stored in the instruction read buffer 120. There are 4 instruction read buffers 150 in FIG. 19, which are correspondingly named as A, B, C, and D. The said 4 IRBs are connected by bus 157 and 168. Bus 157 are cache address buses, a total of 4, each of which is output by the track line 151 of one of the 4 IRBs above, and is received by all 4 IRBs. These 4 buses 157 are named by the IRB name of the drive bus as A, B, C, D. Each of the said 4 IRBs also outputs a matching request signal to all 4 IRBs, named as A, B, C, D. The matching requests are divided into sequential matching requests and branch matching requests, the difference is that the sequence matching request does not need to move the flag write pointer 138, while the branch matching request controls the flag write pointer 138 to shift to the right bit. There are 4 comparators 154 in each IRB, named as A, B, C, D; When an IRB receives a matching request signal, its corresponding comparator will compare the L1 cache block address BN1X on the corresponding bus in bus 157 with the BN1X address stored in register 153 in this IRB, and the comparison result controls the selector 155 to select the L1 cache block offset BNY on the corresponding bus in bus 157 to store in the register 86 of the tracker 131; the comparison result also controls the selector 156 to select the flag and the flag write pointer on the corresponding bus in bus 168 to store into the flag unit 152 of this buffer. The selector 159 selects one bus of the 4 buses 157 to send to the L1 cache.

The bus 168 is flag buses, a with total of 4 buses, each is the output of a the flag unit 152 of the above 4 IRBs, and are received by all 4 IRBs; The 4 flag buses 168 are also named after the name of the driver bus IRB, as A, B, C, D. 4 flag buses 168 A, B, C, D output by 4 IRBs, as well as 4 sets of bit lines (such as bit line 118) are sent to processor core. Accordingly, each of the 4 IRBs outputs a ready signal A, B, C, or D to the processor core to inform processor core to receive the flags on the flag bus 168 of this buffer and the [symbol] Ops on the bit lines (such as the bit line 118, etc.). The processor core then sends branch decision 91 and the flag read pointer 171 to each IRB to control their flag unit 152. In the tracker that controls the L1 cache, the L1 cache address output by the adder is sent to the selector 155 of each IRB via bus 129, then the controller in IRB will select a selector to select bus 129 in a ‘valid’ IRB to receive the address sent by the L1 cache tracker, and to save its BN1X into register 153, and the BNY is stored into the register 86 via selector 85.

In FIG. 19, each selector 85 in the tracker of IRB selects the output of adder 94 by default, to make the read pointer 88 to provide sequential (but not necessarily continuous) BNY to control the instruction read buffer 120 to provide sequential μOps; When the comparator 154 matches in this buffer 150, and the state of this buffer is ‘available’, the selector 85 selects the branch target address that is output by the selector 155 to make read pointer 88 to control the instruction read buffer 120 to provide branch target μOps. The register 86 in each IRB tracker is controlled by the stream line status signal 92 output by the processor core. When the processor core cannot receive more μOps, it will stop the update of each register 86 by signal 92, and make each buffer 150 to suspend sending μOps to the processor core. In this embodiment, the selector 85, register 86 and adder 94 in the IRB tracker only need to handle block offset address BNY of L1 cache block.

Assume the read pointer 88 in the B instruction read buffer 150 points to the μOp segment where branch μOp 141 is located in FIG. 18. After being decoded by decoder 115, the BNY in read pointer 88 controls the bit line 119 and sends μOps to processor core via B set bit line 118, etc.; at the same time, the flag 140 and flag write pointer 138 (hereinafter referred to as flags) stored in flag unit 152 of B instruction read buffer 150 will drive the B bus in the flag bus 168, and set the ready signal B as ‘ready’. The processor core will then receive flags on the B bus in the flag bus 168 according to that signal, and use the flag to mark all valid μOps sent by the B set bit line and execute these μOps. The read pointer 88 in B instruction read buffer 150 also points to track line 151, and reads entries of branch point 141 (the branch target address of branch point 141 on μOp segment 146), and sets it on the B bus in bus 157, and sends the branch matching request signal to all 4 IRBs. After receiving this request, each IRB will make the B comparators in their respective comparator 154 to compare the BN1X address stored in their respective registers 153 with the address on bus B in bus 157.

Assume the comparison result of B comparator in comparator 154 of A IRB 150 is identical, and the status of A IRB 150 is ‘available’, then that comparison result controls the selectors 155, 85 of A IRB 150 to select the BNY of the branch target address on [symbol] Op segment 146 on the B bus of the bus 157 to store into the register 86 of the A IRB 150 to update the read pointer 88; The comparison results also control the selector 156 of the A IRB 150 to select the flag and hierarchical branch pointer on B bus in flag bus 168 to be stored in flag unit 152. According to the branch matching request, the flag unit 152 will move the input flag write pointer to the right in a bit, which is now pointing to the left bit, write ‘1’ in that left bit to make it become the flag of the [symbol] Op of the μOp segment 146 and place the flag on the A bus of flag bus 168. The decoder 115 in A 150 IRB decodes the BNY on the read pointer 88, and controls to send the μOp segments on the μOp segment 146 to the processor core via bit line 118. The controller in B IRB 150 (as 87 shown in the embodiment of FIG. 16), when the output BNY of its adder 94 is greater than the SBNY of the entry field 75 output by its track row 151, will send a synchronizing signal to inform A IRB that it is transmitting branch source operations. After receiving this synchronizing signal, the A IRB will send a ‘ready’ signal A to the processor core. The processor core receives the flags on the A bus in the flag bus 168 according to the ‘ready’ signal A, and uses that flag to mark all valid μOps sent by the A set word line and execute these μOps.

If the comparison result of the B comparator in the comparator 154 in A IRB 150 is ‘identical’, but the status of A IRB 150 is ‘unavailable’, then the output of the selector 155 will be temporarily stored (not shown in FIG. 19). After the status of A IRB 150 becomes ‘available’, it will be selected by selector 85 to be stored into register 86; the output of selector 156 is also temporarily stored (not shown in FIG. 19). After the status of A IRB 150 becomes ‘available’, it will be stored into flag unit 152, and the next operations are the same as above.

The selector 85 in B buffer 150 makes default selection to the output of adder 94 for the register 86 to update, and the values in read pointer 88 are added per cycle by read width 135. In a μOp segment including the branch μOp 141, the flag write pointer 138 points to the right bit of the flag. The above mentioned second condition can be used to control the read width to determine the posterior boundary of the μOp segment, that is, the address of the branch μOp. The read width can be limited by methods such as basing on SBNY address, to make the last valid μOp in the μOps sent by B set bit line 118 as a branch μOp, at the same time, the original flag is sent by the B bus in the flag bus 168, and the ‘ready’ signal is sent to the processor core through the B ready bus. In the sequential next μOp segment (here, it starts from the μOp after the branch μOp 141, that is, μOp segment 142), after read pointer 88 adds with read width 135, the next reader pointer will point to the first μOp after the branch operation (the first μOp of the μOp segment 142), and then plural μOps starting from this μOp will be sent. At this point, as crossing over the branch point, so the flag write pointer 138 in B buffer 150 moves to right by a bit (it crossed over the right border and turns around to the left to point to the left bit), then write ‘0’ in this bit. Updated flag will be sent via B bus in flag bus 168, and a ‘ready’ signal will be sent to the processor core by B complete bus. If the branch μOp 141 is the last branch μOp of L1 cache block, at this point, it is the end track point entry that is read from track line 151 addressed by the read pointer 88 of B IRB 150, and the address in this entry is put on the B bus of bus 157. The controller in buffer B determines it as end track point if the SBNY in the entry exceeds the L1 cache block capacity, and issues a sequential matching request to the IRB B. Each IRB compares the address on the B bus of the bus 157 with the address in their register 153, and the result shows no matching. Therefore, the cache system controls the selector 159 to select the address on bus B in bus 157 to send to the L1 cache tracker.

Thus, each (source) IRB 150 reads the entry automatically in its track row 151 with the read pointer 88 and sends it to each (target) IRB 150 for matching via the bus driven by the source buffer on address bus 157. If target IRB 150 matches and is valid, the flags on the source bus coming from the flag bus 168 are stored into the flag unit 152 in the target IRB 150. If the said source entry is not the end track point, then (as crossing over branch point) update the flags; if the source entry is the end track point, then (as not crossing over branch point) keep flags unchanged; The flags in the target IRB 150 are put on the bus driven by the target IRB 150 in the flag bus 168. And the BN1X of above source entry will be stored in the register 153 of the matched target IRB 150, and the BNY is saved into register 86, for starting using the read pointer 88 in the matched target IRB 150 to control the inside 120 to send μOps. When the source IRB 150 sends a synchronous signal to the target IRB 150, target IRB 150 sends the target ‘ready’ signal to the processor core. Then, the selector 85 in target cache 150 selects the output of adder 94, and the read pointer 88 steps on. If the address BN1 read from the source table entry is not matched in any IRB 150 buffer, then the selector bus 159 selects the bus containing that address to send to the L1 cache to read the corresponding L1 cache block. If the table entry is the end track point, then the cache blocks, tracks and other information read from the L1 cache and track table will be stored in source IRB 150, and flags in source IRB 150 will be unchanged. If the table entry is not the end track point, then the cache blocks, tracks and other information read from the L1 cache and the track table will be stored in another ‘available’ state buffer 150, and flags from the source IRB 150 will be stored in the flag unit 152 of this ‘available’ buffer 150 and upgraded.

On such operation, the address pointer 88 in each IRB 150 will both control each respective 120 to continue to provide μOps to the processor core, and automatically checking the branch target address in corresponding control flow information (tracks) of these μOps. And the target addresses of these branches are matched between each IRB 150, if no match is made, it will read L1 cache block from L1 cache to upgrade IRB, and automatically continue to provide μOps on all possible branch tracks after the branch point that has not been made a branch decision for the processor core for speculative execution. The processor core executes the branch μOp to generate branch decision, and uses the branch decision to abort the μOps on the traces that are not selected to execute, and controls each IRB to abort the address pointer on the branch trace of non-selected bus. Please refer to the following embodiment based on FIGS. 18 and 19.

The processor core executes the branch μOp 141 in FIG. 18. At that time, the flag read pointer 171 points to the left bit of each flag 140, and A IRB 150 is sending the μOps of the μOp segment 148, whose flag is ‘10x’; B IRB is sending the μOps of the [symbol] Op segment 144, whose flag is ‘00x’; C IRB is sending the μOps of the [symbol] Op segment 149, whose flag is ‘1x’; D IRB is sending the μOps of the [symbol] Op segment 145, whose flag is ‘01x’. The processor core makes a branch decision ‘1’ and sends it to each IRB 150 via bus 91. The flag read pointer 171 selects the left bit of each flag 140 and compares them with the branch decision value ‘1’ on the bus 91. The IRB 150 whose results are different stop their operations, and their states are set as ‘available’. Therefore, B IRB 150 (μOp segment 144), D IRB 150 (μOp segment 145) stop sending the μOp, and their states are set to ‘available’. Accordingly, the processor according to the branch decision 91 aborts the execution of the μOps in the [symbol] Op segment 142, 144 and 145, which are partially executed in the processor core. A and C IRB 150 continue sending the [symbol] Ops in the μOp segment 148 and 149 to the processor core; and continue reading the entries in their track row 151, and sends the branch target address in the entry to the IRB 150 for matching. If a match is reached in B and D IRB 150, then the subsequent μOp segments of the 148 and 149 [symbol] Op segment are sent to the processor core by the control of the address pointer 88 of the B and D IRB 150. If it does not match, then it reads a cache block from the L1 cache to store into the ‘available’ B and D IRB 150, and the block is sent to the processor core by the control of the address pointer 88 of the B and D IRB 150.

FIG. 20 is an embodiment of a multi-issue processor system in which the instruction read buffer provides a multi-layer branch of μOps to a processor core at the same time. In this embodiment, the L2 tag unit 20, the block address mapping module 81, the L2 cache 21, the instruction scan converter 102, the block offset mapper 93, the correlation table 104, the track table 80, and the L1 cache 24 are identical to those in FIG. 16. The target tracker 132, comprising the adder 124, the selector 125 and the register 126, generates the read pointer 127 to address the L1 cache 24, the track table 80, the correlation table 104 and the block offset mapper 93; Wherein the block offset mapper 93, according to the read pointer 127 as mentioned above, provides read width 65 for the target tracker 132. And bus 161, 162, 163 are also added in FIG. 20; wherein bus 161 sends the entire L1 cache block from the L1 cache 24 to the instruction read buffer 150, and the bus 162 sends the control signal of the instruction read buffer 150 to control the selector 159, and the selector 125 and register 126 in the tracker 132, and the bus 163 sends the entire track in the track table 80 to the track row 151 in 150, wherein the address with BN2 address format is selected by the controller 87 and put on the bus 19 via the bus 89 and the selector 95 to be mapped into BN1 address (i.e. the function of the bus 89 of the above embodiment) and to be stored back into 80 to bypass to 163. The L1 cache 24 sends valid μOp via bus 48 to the processor core 128 under the control of the read pointer 127 and the read width 65. The instruction read buffer 150 is shown in FIG. 19. Each instruction read buffer 150 sends μOps to the processor core 128 via respective bit lines 118, and sends the corresponding flags of μOps to the processor core 128 via flag bus 168. The processing of indirect branch μOps, and the generation of the read width 65 and so on are the same as that of the embodiment of the FIG. 11, so no further description is made here. The processor core 128 is like the processor core 98 in FIG. 16, but the difference is that it generates flag read pointer 171 and the branch decision 91 and they are compared with the flags of the [symbol] Ops being executed and the flags in each IRB 150, and decide to abort part of the [symbol] Ops inside and addresses in the tracker in part of the 150s.

The below illustration will be made based on FIG. 19 and FIG. 20. Assume that when the C IRB reads one entry of its track row 151 using its read pointer 88, it will send the BN1 address in the entry through the C bus of address bus 157 to each instruction read buffer to match, and send a C matching request. If this request is not matched in any IRB while the B and D IRB 150 states are available, then the controller in IRB controls the selector 125 and 159 via bus 162 to select the BN1 address on the C bus in the address bus 157 to store into the register 126 of the tracker 132 of the L1 cache to be the read pointer 127. The controller allocates the B IRB 150 to receive the L1 cache block read from the L1 cache and the corresponding information, and controls the selector 156 in B IRB 150 to select the C bus in the flag bus 168. The flag on C bus in 168 is stored into the flag unit 152 in the B IRB 150. If that entry is not end track point, and the C matching request is a branch matching request, then the 152 moves the write pointer right by one bit according to the branch matching request, and writes ‘1’ into the flag bit pointed by the moved write pointer to indicate the branch attribute of that μOp segment, to generate new flags. If the entry is end track point, and the C matching request is fall-through matching request, for in the process the branch point of the instruction is not crossed, the flag unit 152 in the B IRB 150 stores that flag directly without modifying it, and sends it to the processor core 128 via the B bus in the flag bus 168.

The read pointer 127 addresses the L1 cache to read the entire L1 cache block to send to the instruction read buffer 150 in B IRB 120 to be stored. Also, it uses the BNY in read pointer 127 as the starting address, and based on the pointer and the read width 65 calculated by the entry 33 in the block offset mapper 93 addressed by the pointer, directly reads from the L1 cache 24 to send valid [symbol] Ops to the processor core 128 via the cache specific bus 48. The processor core identifies these μOps with flags from the B bus on the flag bus 168 of the available B IRB 150. Meanwhile, the tracks in the track table 80 addressed by BN1X on the read pointer 127 are sent to the B 150 IRB via bus 163, and stored in the track row 151; and the entry 93 in the block offset mapper 33 is stored in the block offset row 122 in IRB 150 via bus 163. The BNY obtained by adding the BNY in the read pointer 127 and the read width 65 by adder 124, along with the BN1X in read pointer 127, is sent to each IRB 150 via bus 129. Selector 155 in B IRB 150 has been controlled by the system controller to select bus 129, therefore, this BNY is selected by selector 85 and stored in register 86 in B IRB 150, and the BN1X is also stored in the register 153 in B 150 IRB. Thereafter, the L1 cache 24 stops sending μOps to the processor core 128, while the B IRB 150 will send μOps to the processor core 128 via its bit line 118.

Therefore, the processor system in the embodiment of FIG. 20 can abort part of the outstanding [symbol] Ops and part of the address read pointer 88 in IRB 150 according to the branch decision 91 and flag read pointer 171. For the detailed operations please refer to the following embodiment.

FIG. 21 is an embodiment of the combined action of branch decision 91 generated by the processor core, the flag read pointer 171, and the flag 140 of flag unit 152 in instruction read buffer 150 to determine the execution trace of the μOp. In each of the flag unit 152 of the IRB 150, there are flag 140, flag write pointer 138, selector 173, and comparator 174. The flag read pointer 171 sent by processor core 128 controls the selector 173 to select one bit in the flag to compare with the branch decision 91 by comparator 174, if the comparison result 175 is different, then abort the operation of this IRB 150, and set the IRB 150 to ‘available’ status, and the address pointer is reallocated by other IRBs that do not abort operations; If the comparison result 175 is the same, then the instruction read buffer 150 continues to operate (such as reading pointer 88 stepping) to control the 120 to provide subsequent μOps to the processor core 128, and to wait to be selected by the next branch decision. After processor core generate search branch decision, the read pointer 171 will move right by a bit, to make the next branch decision 91 to compare with the next bit of the flag 140, all IRB 150 are addressed by the same reading pointer 171. In the embodiment of FIG. 20, the IRB is selected by this method. For example, when four IRB 150 in FIG. 20 output μOp segments 144, 145, 148, and 149 in the embodiment of FIG. 19, if the branch decision 91 is ‘1’ at this time, then the IRB 150 (output μOp segments 144 and 145) with the flag as ‘00x’ and ‘01x’ will stop operation, and their states are changed to ‘available’; while the IRB 150 (output μOp segment s148 and 149) with the flag as ‘10x’ and ‘11x’ will continue to send [symbol] Ops, and the next branch target address in its track row 151 will be sent to each IRB for matching via bus 157 as described above. And, when the number of μOps in μOp segment 164 is far larger than the number of μOps in μOp segment 142, causing flags in each IRB 150 to be ‘00x’, ‘01x’ and ‘1xx’ (output μOps segment 144, 145 and 146, and another 150 can be in the ‘available’ state), if the read pointer 171 points to the left bit of flag 140 in each IRB 150 (branch decision corresponding to branch point 141), the branch decision 91 is ‘1’, then the IRB 150 with flags of ‘00x’ and ‘01x’ (μOp segment 144 and 145) will stop operation, and the states are changed to ‘available’; and IRB 150 with flag of ‘1xx’ (output μOp segment 146) will continue to send the following [symbol] Ops, and the next branch target address in track row 151 will be sent to each IRB 150 for matching via bus 157.

When the processor core 128 has not made branch decision to a branch point, it will speculate execute the μOps in plural traces after the branch point at the same time, after that the branch decision 91 will select the execution result of one trace to commit to the architecture register, and abort the μOps on other traces. FIG. 22 shows two typical out-of-order multi-issue processor system cores. FIG. 22A includes processor core 128 and cache system (such as IRB 150). The processor core 128 includes a register alias table and allocator 181, reorder buffer 182, Reservation Station 183 contains multiple entries, Register File 184, and plural Execution Unit 185. When the μOp is sent from IRB 150 to 128, register alias table and allocator 181 will check the register alias table according to the architecture register address in μOp, and rename the register and allocate the ROB entry, and fetch operands from register file 184 or ROB 182, and issue the μOps and operands to an entry in the reservation station 183. When all operations of a μOp in the 183 entry are valid, the reservation station 183 will dispatch this μOp to the execution unit 185 for execution. The reservation station 183 may send plural μOps to different execution units 185 each cycle. The execution unit 185 execution result is stored in the entry of the ROB that is allocated for this [symbol] Op, and is also sent to any entry of the reservation station whose operand is that result, and the reservation station entry corresponding to the μOp is released for reallocation. When the μOp is decided to be non-speculative, the μOp ROB state is marked as ‘finished’. When the head singular or plural entries of ROB 182 are ‘finished’, the results in these entries are committed to the register 184, and the ROB entries are released for reallocation.

Speculate Out of Order Execution is not executed in order, but the issuing and committing are sequential. The processor core 98 based on branch prediction executes a single trace determined by branch prediction; the issue sequence of the trace is sent sequentially by the cache system to inform the processor core, and the processor core 98 stores it sequentially into the ROB. The name dependency (WAR,WAW) of the processor core 98 to each μOp is removed by the rename of register; and true data hazard (RAW) is promised by the ROB entries recorded in the reservation station according to the order that μOps are sent in. The commit order is guaranteed by the ROB order (essentially FIFO buffers). In the embodiment of FIG. 20, the processor core 128 in the embodiment speculate executes plural traces after the branch point, so a method is needed to make sure the issue and the commit to be in order. There are many methods to achieve the goal. The following is an illustration of the flag system in the embodiment of FIG. 18.

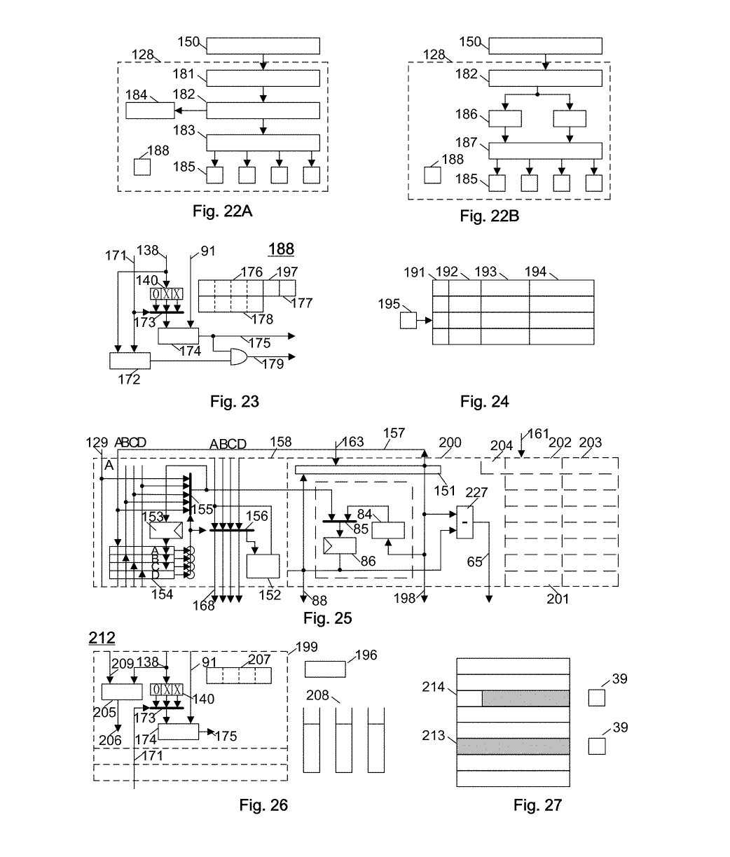

In FIG. 22A, the register alias table and distributor 181 in the processor 128 can simultaneously process a set of plural [symbol] Ops from plural IRB 150 respectively through their word lines 118 and search the register alias table to do register renaming, to remove the name dependency; it also allocates entry of ROB 182 for each [symbol] Op; at the same time, it assigns the set of the [symbol] Op a controller 188 to control the allocated 182 entry in ROB. The processor core 128 has a plurality of controllers 188. FIG. 23 is an embodiment of the controller 188 that coordinates the IRB 150 in the embodiment of FIG. 19 and the operation of the processor core 128 of the embodiment of FIG. 22A. In the controller 188, the flag 140, the flag read pointer 171, the branch decision 91, the selector 173, the comparator 174, and the comparison result 175 have similar function and operations with the flag unit 152 in the IRB 150 of the embodiment of FIG. 21; also, the storage field 176, 177, 178 and 197, the comparator 172, the flag write pointer 138, and the flag read pointer 171 are added.

IRB 150 sends the flag 140 generated in the flag unit 152 and the flag write pointer 138 via the flag bus 168, and stores them into the fields of the same number in the assigned controller 188; it also sends the μOp read width 65 to store into the field 197. The ROB entries assigned for each μOp in the μOp set are stored in the field 176 according to the order of the μOps; the storage field 177 has time stamps. Field 178 stores the reservation station table number assigned by respective μOps in field 176. The total number of ROB table entries allocated is equal to the read width 65. At the same time, IRB 150 provides a time stamp to store into the field 177 of the controllers 188 assigned in the same cycle.

For true data hazard RAW, the set of [symbol] Ops in the corresponding field 176 of the controller 188 needs to check their hazard according to the [symbol] Op order; if there is RAW hazard between the μOps, then when it assigns reservation station for the [symbol] Op of the read register, it writes the ROB entry number of the [symbol] Ops of the corresponding write register into the reservation station to replace the register address. In addition, it needs to detect the hazard between it and the μOps on the same branch before this set. There are two cases, one is to compare the new assigned controller 188 flags with the flags in other valid controllers 188, if they are identical and the time stamps of the other controllers 188 are ahead of the time stamp 177 of the new assigned controller 188, then it needs to detect the RAW hazard between the μOp in other controllers 188 and the μOps in the new assigned controller 188. The second is to detect the valid controllers 188 whose flag write pointer 138 has a higher branch level than the write pointer 138 of the newly assigned controller 188; In the embodiment of FIG. 18, the write pointer 138 on the left has higher branch level than the write pointer 138 on the right, but because the flag 140 is a circular buffer, therefore it identifies the branch level of the write pointer 138 according to the position of the flag read pointer 171. If the pointer 171 points to the middle bit of the flag 140, the write pointer that points to the right bit 138 is the grandfather branch, whose branch level is higher than the write pointer 138 that points to the parent branch pointing on the left. The flag 140 in the newly assigned controller 188 is compared with flag 140 in all the controllers 188 which have higher branch levels. The compared bits start from the higher 1 bit of the new assigned write pointer 138 and end at the read pointer 171. For example, if the read pointer 171 points to the middle bit, and the write pointer 138 of the new assigned 188 points to the left bit, the it compares the middle bit and the right bit. If the comparison result is same, then the [symbol] Op block corresponding to the controller 188 with the higher branch level is ahead of the [symbol] Op block corresponding to the new assigned controller 188 according to the order of execution, so the branch detection is needed. By detecting the above two cases, if there is RAW hazard, then it needs to store the ROB entry number of the [symbol] Op number of the write operand to replace the register number when it issues the [symbol] Ops of the read operand to the reservation station.

Each of the μOps issued to the reservation station 183 is dispatched to the execution unit when its operands to be used are valid and the execution units needed by the μOp needs are available, and the execution result is returned to the ROB entry assigned for that μOp to store. At the same time, there can be multiple branches of μOps to be sent by the reservation station, and to be executed by the execution unit. If the buffer system of the embodiment of the FIG. 20 provides [symbol] Ops for the processor core in the FIG. 22A, then the processor core 128 does not need to calculate the branch address of the direct branch μOp. When the direct branch μOp is being executed, its branch target μOps may have been issued or even have been executed. Only the indirect branch μOp requires the processor core 128 to generate the branch target address. When the processor core 128 executes the branch μOp to generate the branch decision 91, the branch decision 91 is sent to each of the valid controllers 188 in comparison with one bit in the flag 140 selected by the selector 173 controlled by the read pointer 171 to produce a comparison result 175. The comparison may have the following results. If the comparison result 175 is ‘different’, then abort the execution of the μOps in each of the reservation stations recorded in the field 178, and the reservation stations are set to the available state; the ROB entries recorded in the fields 176 are returned to the resource pool; and the controller 188 is set to ‘invalid’ so that the register alias table and allocator 181 can assign new tasks to these reservation stations 183, ROBs 182 entries and the controller 188. If the comparison result 175 is ‘the same’, the shared read pointer 171 is compared by the comparator 172 with the write pointer 138 in the controller 188 to generate the result. If the comparison result 175 is ‘the same’ and the comparison result of the comparator 172 is ‘different’, then each of the reservation stations recorded in the set of field 178 and each ROB entry recorded in the field 176 continues to operate to wait for the selection of the next branch decision; if the comparison result of the comparison result 175 and the comparator 172 are both ‘the same’ (in which the ‘and’ operation result 179 of the two result is ‘the same’), then the branch status of the ROB entries recorded in the field 176 of the controller 188 is set to ‘valid’. If the comparison results 179 in plural controllers 188 are ‘the same’ at the same time, then the plurality of controllers 188 correspond to the μOps issued by the same [symbol] Op segment in different clock cycles, so at this time, according to the time stamp 177 of each controller 188, they are stored into the FIFO by the time order (the early ones are stored first).

When the μOp is executed in the execution unit 185, the execution result is stored in the corresponding entry in the ROB 182, and the execution status bit of the entry is also set to ‘completed’, and in the corresponding controller of the ROB entry, the field 176 status that records that ROB entry in the field 176 is also set to ‘completed’. The controller number that the commit FIFO output points to a controller 188, wherein the corresponding entries whose status are ‘completed’ recorded in the field 176 are orderly committed to the architecture register 184, and the committed ROB entries are also returned to the resource pool for the use of the register alias table and the allocator 181; when all the corresponding ROB entries of all valid entries in the field 176 has been committed, the controller 188 is also set to ‘invalid’ and returns to the resource pool preparing to be used. At this point, the read address of the commit FIFO steps on, and the next entry of the commit FIFO is read out, and the pointed controller 188 starts committing the corresponding ROB entries. The flag system and the commit FIFO guarantee the sequential commitment of the μOps set, and the ROB entry sequence stored in the field 176 of the controller 188 guarantees the sequential submission of the μOps within the set.

Each time the processor core finishes comparing with the branch decision, the read pointer 171 is shifted right by one bit so that the resulting next branch decision 91 is compared with the next bit in the flag 140 in each controller 188. When the system is reset, the read pointer 171 and the write pointers 138 in each IRB 150 are set to the same value, for example, all pointing to the left bit, to synchronize the read pointer 171 and each write pointer 138. So that the flag system makes the caching system cooperate with the processor core 128 in the embodiment of FIG. 20 to speculate execute all traces of the branches of several levels and according to the branch decision, abandon the [symbol] Ops on several traces in the process of distribution, execution, or writing back, and only the execution result of the [symbol] Ops decided by the branch decision are committed orderly to the architecture register. The existing sequential or out-of-order multi-launch cores only needs to slightly modify their ROB so that they can cooperate with the caching system described in FIG. 20 under the control of the controller 188 to achieve the full trace speculate execution. The processor of this structure does not suffer from the loss of performance due to branching.

FIG. 22B is another typical out-of-order multi-issue processor core, which is an improvement over the embodiment of FIG. 22A. It includes the processor core 128 and the cache system (such as IRB 150). The processor core 128 comprises a reorder buffer 182; a Register Physical File (RPF) 186, which may be divided into a plurality of sets according to the data type stored therein; a scheduler 187 storing a plurality of entries, each of which corresponds to a μOp; a plurality of execution units 185. The basic working principle is similar to that of the embodiment of FIG. 22A, except that the operand and the execution result are no longer stored in the reservation station 183 and the reorder buffer 182 in FIG. 22A, but are stored together in the register physical file 186, and in FIG. 22B, only the addresses of the operands stored in the register physical file 186 are stored into the plural entries of the scheduler 187 in which the similar function of the reservation station is executed, and the reorder buffer 182 only stores the address pointing to the execution result stored in the register physical file 186, in order to avoid duplication of data storage and movement. The μOps to be executed are sent from the IRB 150 to the processor core 128, which allocates the ROB 182 entries in the order that the μOps are sent in, checks the register table and renames the registers according to the register file address in the μOp, and issues in the entry of the scheduler 187 from the address of the operand in the register file 186 or the ROB 182. When all the operands of a μOp in the scheduler 187 are valid and the execution unit required by the μOp is available, the scheduler 187 dispatches the μOp to the available execution unit to execute, and uses the corresponding operand address of the [symbol] Op to read the operand in the read register physical file 186 to send to the execution unit; the scheduler 187 can send a plurality of μOps to different execution units 185 per cycle. The result of execution by the execution unit 185 is written back to the entry in the register physical file 186, where the register physical file 186 is addressed by the execution result address stored in the assigned ROB 182 entry of the μOp. The scheduler 187 corresponding to the μOp that completes the operation is released for reallocate. When the μOp is determined as non-speculative, the state of the ROB 182 entry of the μOp is marked as ‘completed’, and when the singular or plural entry of the head of the ROB 182 is ‘completed’, the addresses stored in these entries are committed to the register table in the processor core 128 so that the architecture register addresses stored in these entries are mapped into the execution result addresses stored in the same entry, and these ROB entries are released for reallocation. The embodiment shown in FIG. 22B is the same as that of FIG. 22A except that FIG. 22B stores and moves the address of the central stored data instead of the data itself. Therefore, the controller 188 in the FIG. 23 may also control the processor core 128 in FIG. 22B to cooperate with the cache system in the embodiment of FIG. 20 to execute the above-described full trace speculate execution by changing the storage 178 in the controller 188 to the entry number in the storage scheduler 187, which operation is similar to that of the embodiment of FIG. 22A, and is not repeated here.

In the out-of-order multi-issue processor system of FIGS. 22A and B, the operations (or instructions) are issued in sequent to correctly express the logic relationship of the program, which is temporarily stored in the ROB 182 so that the execution results are committed in this order to meet the original meaning of the program; and the execution of the μOps (or instructions) is out-of-order so that the relevant μOps do not affect the irrelevant execution of the μOps (or instructions) that are followed in sequence, and the registers used are also renamed to resolve the name hazard. The full trace speculate execution of the present disclosure requires simultaneously speculate executing one of plural levels of branches of plural [symbol] Ops (or instructions) traces that contains different numbers of [symbol] Ops (or instructions), so that the simple sequence is not enough to guarantee the logic of the program is correctly executed and expressed. The present disclosure issues the [symbol] Ops (or instructions) in the unit of [symbol] Op (or instruction) segment that ends with single [symbol] Op (or instruction), and uses a flag (flag) system to send the branch relationship of the [symbol] Op (or instruction) segments from the issue end (IRB in this disclosure) to the commit end (ROB in this disclosure), and uses the branch decision 91 generated by the processor core to select one branch of the branch to commit to guarantee the logic of the program is correctly executed and expressed. Its operation does not affect the execution of the program between the issue and the commitment; therefore, it can work together with various execution modes such as sequential execution or out-of-order execution, various instruction set architectures such as fixed or variable-length instruction set, various implementation technologies, such as the register renaming, the reservation stations, the schedulers and so on.

Since the embodiment in FIG. 23 implements a broader speculative execution than the existing processor, the ROB 182 should have a wider write width than the existing ROB so that it can simultaneously write from the plural sets of plural IRBs 150, each set of which contains a plural number of μOps; but its read and write order is not required to be consistent, because the order of the commitment is guaranteed by the flag system through the controller 188 and so on. From the above description of the embodiment of FIG. 23, the operation of the controller 188 is closely related to the ROB 182. Therefore, the entries of the ROB can be divided into sets, with each set of entries corresponding to a controller 188, which simplifies the status bit exchange between the controller 188 and the corresponding ROB entry, and simplifies the structure of the controller 188. FIG. 24 shows the structure of the set of ROB entries, with a plurality of entries. In each entry, the field 191 is the execution status bit which records whether the execution unit has finished the execution, the field 192 is the μOp type, the field 193 is an architecture register address of the to be committed execution result of the ROB entry, and the field 194 stores the execution results of the execution unit 185, etc. The address unit 195 steps on to generate sequential addresses to control the access to the ROB entry. Since the address of each entry in the ROB set is contiguous, the field 176 in the corresponding controller 188 only needs to record the BNY address of the starting μOp of the μOp segment stored in the ROB block. The controller 188 and the ROB entry may be further merged into one ROB block, i.e. all the modules in FIGS. 23 and 24 are merged into one ROB block, and each ROB block has a block number. The field 178 is not required in the controller 188 at this time. And the address unit 195 is controlled by the read width 65 in the storage field 197 in the controller 188, and only the entries within the read width from the lowest address are valid entries. When the branch decision 91 and the flag read pointer 171 are ‘identical’ compared with the flag 140 and the identification write pointer 138 in one ROB block, the block number of that ROB block is stored in the commit FIFO. When the output of the commit FIFO points to a certain ROB block, the address unit 195 in the ROB block checks the execution status bit field 191 of the first ROB entry, stops if the field 191 is ‘invalid’; if the field 191 is ‘valid’, the execution result in field 194 is moved according to the μOp type in the field 192. For example, when the type in field 192 is load or arithmetic logic operation, the execution result is committed to the register 184 addressed by the register address in field 193. The address unit 195 increases its address to sequential commit its each valid entry until it reads the last entry indicated by the width 65 in the field 197. At this time, the ROB block sends a signal to make the read pointer of the FIFO is step on and read the next ROB block number in the commit FIFO, and the ROB block pointed to by that ROB block number starts to commit, and the operation is as described above. If used to control the processor in the embodiment of FIG. 22B, the field 19 in the ROB block stores the physical register 186 address of the execution result without storing the result itself. The reorder buffer ROB 210 can be composed of a plurality of ROB blocks 190 to distinguish the reorder buffer 182 in FIG. 22.

The existing multi-issue processor requires the cache system to store instructions or μOps required by the processor core in the instruction buffer, such as the IRB 150 in FIG. 22, and then transmit and store them into the storage entries in the reservation station 183 or scheduler 187. The IRB 150 in the implementation of FIG. 19 can be merged with the reservation station or scheduler so that the IRB can have the function of storing the entries in the reservation station or the scheduler. FIG. 25 is an embodiment of an IRB 200 that can also be a reservation station or a scheduler to store entries. The IRB 200 is used as a scheduler to store the entries in the following example, and the case that the IRB 200 used as a reservation station to store the entries is similar. In this embodiment, the scheduler that does not contain the storage entries is marked by 212 to distinguish it from the existing scheduler 187 containing the storage entries, but the functions of these two are the same.

The read scheduler 158 in the IRB 200 is similar to the read scheduler 158 in the embodiment of FIG. 19 and is also responsible for matching the branch target address from the other instruction read buffers from the bus 157 or itself; and generating flags for the sent instructions via the flag bus 168 to send to the other instruction read buffers 200 and other units in the processor core, which are described in the embodiment of FIG. 19 and is not repeated here. However, it does not perform the comparison of the flag read pointer 171 and the branch decision 91 generated by the branch unit on the flags in the flag unit 152, and the abandonment of the address pointer is now determined by the scheduler 212. The read buffer 120 of the instruction read buffer 150, which is driven by the zig-zag word line to send plural instructions with continuous addresses, is also replaced by the register set 201. There are plural entries in the register set 201, and the number of entries is the same as the number of instructions in a L1 cache block, and is addressed by the block offset address BNY. There are two fields in each entry, the field 202 stores μOps or the information extracted from μOps, such as the type of operation (OP), the architecture register address, the immediate number, etc.; The field 203 stores the values in the scheduler storage entry, such as the renamed operand physical register address, the operand state, the target physical register address, etc., and the entire register set 201 has a field 204 for storing the ROB block number assigned for the IRB. The scheduler 212 with the IRB 200 as the scheduling storage and the allocator 21 can read the μOps or μOp information in the field 202 and the operand physical register address, the operand state and the target physical register address in the field 203. The allocator 211 can read the μOp or μOp information in the field 202 and can write the operand physical register address and the target physical register address in the field 203. The execution unit can write the operand state in the field 203. Extracting information from instruction to store in field 202 may be performed by instruction convertor 102 while it converts instruction to executable form and store in L1 cache 24; or may be performed when the instruction or μOp is stored into the IRB 200.

The tracker in IRB 200 also varies depending on the method that the entry is read. The IRB 200 does not send out a number of instructions according to itself in each cycle but outputs a starting address by its tracker read pointer 88, and the track row 151 addressed by the read pointer 88 outputs the SBNY field 75 in the entry as the end point address to output. And the entry between the start address and the end address in the register set 201 in the IRB 200 is accessed by the scheduler and so on. Where the tracker uses the incrementor 84 but not adder 94, and the input of the incrementor 84 is connected to the SBNY field 75 on the output of the track row 151. In addition, a subtractor 121 is added to find the difference between the end address and the start address as the read width 65 for ROB to use.

The allocator 211 contains an address extractor, an instruction hazard detector, and a register alias table. The allocator 211 is triggered by the ready signal from the IRB 200, and stores the corresponding flags on the flag bus 168. The address extractor reads the entry 202 of the IRB 200 between the start address and the end address from the IRB 200, and extracts the operand architecture register address and the target architecture register address, which are send to the instruction hazard detector for hazard detection. The instruction hazard detector also detects its hazard with the operand architecture register address in the IRB 200 according to the target architecture register address of the parent instruction segment sent by the ROB 210. The instruction hazard detector queries the register alias table based on the result of the detection, and the register alias table renames the operand architecture register address in field 202 to the operand physical register address and stores it back into the field 203 of the IRB 200 entry. The register alias table also renames the target architecture register address in the field 202 into the target physical register address and stores it into the ROB block 190 allocated by the instruction segment in the IRB 200. The 211 records the assigned physical register resources by ROB blocks respectively. There are also flags in each list. In 211, the branch unit generated flag read pointer 171 selects one of the flag 140 from the flags in the lists and compares it with the branch unit generated branch decision 91. The physical registers in the lists, whose comparison result are ‘different’, are released. When a ROB block 190 is completely committed, the physical registers in its corresponding list are also released.

FIG. 26 is an embodiment of a scheduler. The scheduler 212 includes a plurality of controllers corresponding to each IRB 200, and IRB entry accessor 196, and queue 208 corresponding to each execution unit and so on. Each controller has a plurality of sub-controllers 199 which stores the flag 140 sent from the corresponding IRB 200 via the flag bus 168, and the flag write pointer 138; and it also contains a storage unit 207 that stores the BNY address value between the start address on the corresponding IRB 200 bus 88 and the end address on bus 198, wherein each address value has a valid bit; the entire sub-controller 199 also has a valid bit. Each of the sub-controllers 199 also compares the one of the flags 140 stored in the sub-controller with the branch decision 91 with the same comparator 174 as the flag unit 152 in the embodiment of FIG. 18. The scheduler 212 determines the issue sequence according to the flags. The 212 has an issue pointer 209 which is compared with the flag write pointer 138 in the sub-controller by the comparator 205 in each sub-controller to produce the comparison result 206. The entry accessor 196 accesses the field 203 in the entry in the IRB 200 that is pointed to by the BNY by the effective BNY address in the storage unit 207 of the controller sub-controller 199 to determine whether the operand status in the field 203 is valid. If it is valid, then the BNY address, the operation type in the field 202 of the entry with the valid operand, the operand physical address in the field 203, and the block number of the corresponding ROB block in the field 204, are placed in the execution queue 208 that can execute that operation type. Alternatively, only the number of the IRB 200 and the BNY can be placed in the queue, and after they are popped from the head of the queue, the above information is read from the IRB. Thereafter, the valid position of the BNY in the sub-controller 199 is set to ‘invalid’. When the instructions corresponding to all the BNY addresses stored in a sub-controller 199 in the controller are issued and all the valid bits of each BNY address are ‘invalid’, the valid bit of that sub-controller 199 is also set to ‘invalid’. If it is set to issue when the issue pointer 209 is equal to the flag write pointer 138, then when the 212 detects that all the sub-controllers whose issue pointer 209 is equal to the flag write pointer 138 are invalid, it shifts the issue pointer 209 to the right by one bit. At this point it is strictly issued with the branch level, but the μOps of the same level can be issued out of order.

The issue rule may also be set to issue when the issue pointer 209 is greater than or equal to the flag write pointer 138, which allows out-of-order issue to across the branch level. At this time, the right shift of the pointer 209 can be determined by the length of the queue or the amount of the resources, for example, when the queue is shorter than a certain length, the launch pointer 209 is shifted right. The issue priority order may also be determined using the branch prediction stored in the field 76 of entry in the track row 151. At this time, the bus 75 sent from the IRB 200 has a field 76 branch prediction in addition to SBNY. Assuming that the field 76 is a binary bit, the scheduler 212 compares the branch prediction value of the field 76 with the bit in the flag 140 of each entry pointed to by the issue pointer 209, and those with the ‘same’ comparison results are issued in priority. The last μOp in a μOp segment is the branch μOp, which means that the last μOp in the entry of the controller should be the issued in the highest priority. The scheduler 212 may detect whether the SBNY address on the field 75 exceeds the size of the L1 cache block to exclude the end track point (which is not a branch μOp and does not require priority issue) when the 207 is filled in accordance with the start address and the end address. The read pointer 171 generated by the branch unit selects one bit of all the valid flags 140 in the controller 199 to be compared with the branch decision 91. If the comparison result is the ‘same’, the corresponding entry will not be operated, and will continue to issue according to the BNY address in the entry. If the result of the comparison is ‘different’, the valid bit of the flag 140 in the corresponding entry is set to ‘invalid’. If the valid bits in all of the sub-controllers 199 corresponding to one IRB 200 are ‘invalid’, it means the μOps stored in controller 199 pending to be issued are either all issued or all aborted. The state of that IRB 200 is ‘available’ at this time, and the L1 cache block from the L1 cache 24 and the corresponding track and so on can be written to the IRB 200. The IRB 200 is not available when at least one of the active bits in the sub-controller 199 within the controller 212 corresponding to that IRB 200 controller is ‘valid’. That is, whether the IRB 200 content can be overwritten is newly determined by the controller state in the scheduler 212.

FIG. 27 is an embodiment of the L1 cache of the present disclosure. In this embodiment, the L1 cache block may not be capable to store all the μOps corresponding to a variable-length instruction sub-block, so for each of the L1 cache blocks, an entry 39 is added (which is the same entry 39 in FIG. 3). The 39 is added to the row corresponds to the L1 cache block in the storage unit 30 of its address mapper 23, 83 or 93. The 39 stores the position information of the subsequent L1 cache block corresponding to the same variable-length instruction sub-block. Specifically, for example, each bit of the above entries 33, 34, 35, and the μOp in the L1 cache block are all aligned by the most significant BNY (right align), then all the μOps corresponding to a variable-length instruction sub-block are filled into a L1 cache block (such as the L1 cache block 213 in FIG. 25) starting from the most significant BNY bit. If the L1 cache block 213 can accommodate all the said μOps, the corresponding entries 32, 37 and 38 of the L1 cache block 213 are set as described above, and the value in the entry 39 is invalid.

If the L1 cache block 213 is not sufficient to accommodate all of the μOps, an extra L1 cache block (such as the L1 cache block 214 in FIG. 25) is allocated to store the exceeded portion aligned by the most significant BNY (right align). If the L1 cache is a set associated structure that is addressed by an index value, in this case, the extra L1 cache block is in the block address space that exceeds the index value. At this time, the entry 39 corresponding to the L1 cache block 213 is used to record the addresses (BNX and BNY) of the first μOp in the L1 cache block 214. Specifically, if the L1 cache block 214 can accommodate the said exceeded portion, the corresponding entries 32, 37, and 38 of the L1 cache block 214 are set as described above, and the value in the entry 39 is invalid, and the first μOp address (BNX and BNY) in the L1 cache block 214 is stored in the entry 39 corresponding to the L1 cache block 213. If the L1 cache block 214 is also not sufficient to accommodate the exceeded portion, more L1 cache block can be allocated, and as the method described above, all the μOps corresponding to the variable-length instruction sub-blocks are stored in more L1 cache blocks.

If the L1 cache is a fully associated structure, for example, the L1 cache structure addressed by the mapping of the block address mapper 81 in the embodiment of FIG. 7 is not limited by the index value, any L1 cache block can be used as an extra cache. At this time, when the L1 cache block 213 is not sufficient to accommodate all of the μOps, an additional L1 cache block 214 is allocated, and the block number of 213 is stored in the entry 39 of 214 and is set to valid, and the block number of the 214 is stored into the entry of the 81 block address mapper. Since the number of μOps overflows the capacity of the L1 cache block, the address in the entry of the L1 cache block is already different from the BNY address of the μOp. It can store the BNY address of the μOp of the starting entry of the corresponding L1 cache block into the entry 39, and uses the subtractor in the offset address mapper such as 23, 83, 93 to subtract the starting address from the branch target μOp BNY to address the correct entry. In the embodiment of the track table, the BN1X block address (normal or extra) can be stored in the track table 80 along with the correct L1 block. Therefore, the next access to the branch target μOp does not need to do address mapping again.

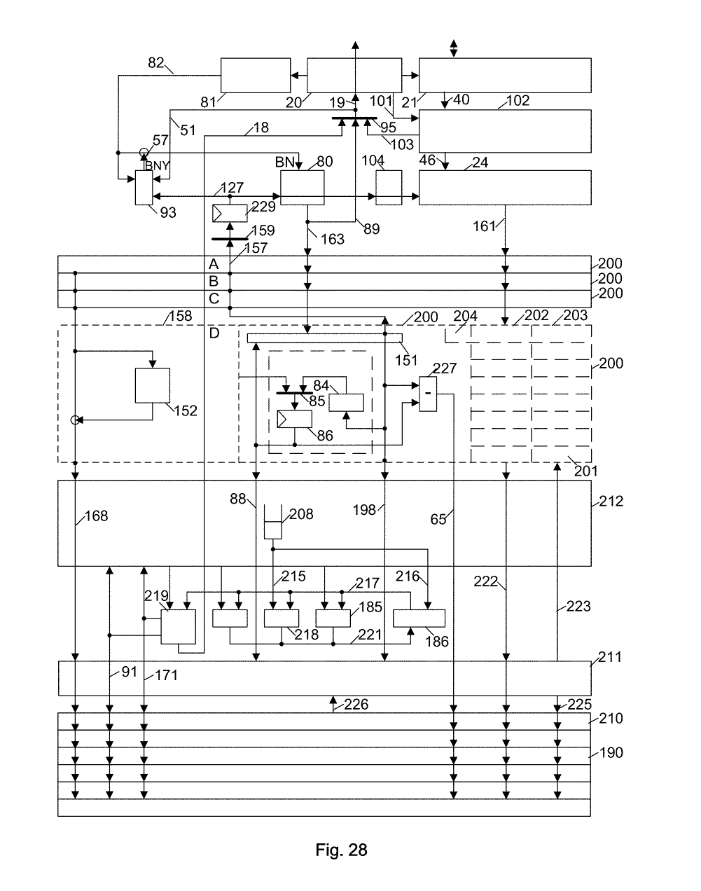

FIG. 28 is an embodiment of a multi-issue processor system that uses the IRB of the embodiment of FIG. 25 to provide multiple layers of branches of μOps for the processor core. In the present embodiment, the L2 tag unit 20, the block address mapping module 81, the L2 cache 21, the instruction scan converter 102, the block offset mapper 93, the correlation table 104, the track table 80 and the L1 cache 24 are the same as those in the embodiment of FIG. 16. IRB 200 is the IRB in FIG. 25, with a plural number. When the branch destination address on the bus 157 does not match in each IRB 200, the selector 159 selects the unmatched address on the bus 157 to directly drive the L1 cache read pointer 127 via the register 229, wherein the BN1X address reads a cache block in the L1 cache 24 is via bus 161, and reads one track of the track table 80 to store into an available IRB 200 via bus 163. The controller checks the track on 163, and if the track contains entry with BN2 address format, then it sends the BN2 address via bus 89, selector 95, and bus 19 to the block address mapper 81 mapping it to a BN1X address, and to address mapper 93 mapping it into BN1Y address. The BN1X and BN1Y address together form a BN1 address. The BN1 address is stored in the track table 80 and bypassed via the bus 163 into the track row 151 of the IRB 200. In addition, the allocator 211, the scheduler 212, the execution unit 185, 218, etc., the branch unit 219, the register physical file 186, and the reorder buffer (ROB) 10 are also included.

Assuming that the address bus 157 has a branch target address, and the flag bus 168 has a flag of its source branch point and the matching request. Assuming that the read scheduler 158 in the D IRB 200 in FIG. 25 compares the branch target address on the bus 157 and finds the match, i.e., the flag unit 152 in the IRB 200 generates and stores the corresponding flags of that branch target μOp segment according to the flag on the flag bus 168, and put them on the D bus to send to the scheduler 212, the allocator 211, and the ROB 210; the ready bus D is also set to ‘ready’. The block offset address BNY in the branch target address on the bus 157, assumed to be ‘3’ at this time, is selected by the selector 85 in the D IRB 200 to be stored in its register 86, and its read pointer 88 is updated to ‘3’ and is output via D bus of bus 88. The read pointer 88 also points to the track row 151 in the D IRB 200 to read entries, in which the stored branch target address BN1X field 72 and the BN1Y field 73 are placed on the D bus of the bus 15, and the D IRB 200 sends match request for each IRB to match. At the same time, the SBNY field 75 of that entry (i.e. the address of the first μOp after the address pointed by the read pointer 88 in the track of the track row 151, assuming the value is ‘6’) is also put on the D bus of the bus 198 to output. The subtractor 227 subtracts the value ‘3’ on the read pointer 88 from the BNY 75 value ‘6’ and adds ‘1’ to obtain the read width ‘4’ and sends it via the D bus of the bus 65.

The allocator 211 is triggered by the ‘ready’ signal on the ready bus D, and according to the address ‘3’ on the D bus 88 and the address ‘6’ on the D bus 75, reads the μOps from field 202 of IRB 200 entries with BNY address 3,4,5,6. The system performs dependency check on the operand register addresses and target register addresses of the μOps. The ROB 210 is triggered by the ‘ready’ signal on the ready bus D and makes each of the controllers 188 executes two operations. One is detecting branch history of the ‘unavailable’ ROB blocks 190 based on the flags on the D bus of the flag bus 168. As described above, the branch history detection checks the ROB block that has higher branch level than the ROB block waiting to be assigned, then sends the target register address in filed 193 of the valid entry of the ROB blocks with grandfather and father flags of the μOp segments being checked allocator 211 via bus 226. Perform dependency check on the said target register with the operand register addresses in the entries with BNY addresses 3, 4, 5, 6. The allocator 211 queries the register alias table according to the result of the dependency check, and renames the register address of each architecture register.

Another operation executed by each controller 188 is to detect the presence of available ROB blocks 190. If there is no available ROB block 90 in the ROB 210, the feedback ‘unavailable’ signal is sent to the scheduler 212, and the scheduler 212 suspends the register 86 in the D number IRB 200 to be updated. If the ‘U’ ROB block 190 in the ROB 210 is ‘available’, it feeds back ‘available’ signal to the scheduler 212, and the flags on the D bus in the flag bus 168 are stored in the flag 140 of the controller 188 of the ‘U’ ROB block 190 and the flag write pointer 138, and the starting address on the D bus of bus 88 is stored into the field 176, and the reading width ‘4’ on D bus of bus 65 is stored into the field 197 of the controller 188, which makes only number 0-3 entries in that ROB block valid. The assigned ROB block 190 label ‘U’ is sent back and stored to the field 204 in the ‘D’ IRB 200.

The allocator 211 executes the hazard detection and the register renaming in the method described in FIG. 26, and saves the renamed operand, physical register address and target physical register address into the field 203 of the 3,4,5,6 entries of the D IRB 200 via the bus 223. The allocator 211 makes the D IRB 200 send the BNY address of the μOp and its operation type, and the target architecture register address to the U ROB block 190 in 210 via bus 222. For example, if the BNY value is ‘5’, the U 190 subtracts the input BNY address ‘5’ with the start address ‘3’ in its 176 field, whose result points to the entry 2. The operation type is stored in the 192 field of that entry, and the target architecture register address is stored in the 193 field of that entry, and the target physical register address is stored in the 194 field of that entry, and the 191 field in that entry is set as ‘unfinished’. The allocator 211 also stores the corresponding target physical register address via bus 225 into the field 194 of entry 2.

The scheduler 212 receives the information that the ROB block 190 has been allocated based on the request on the ready bus D, that is, based on the start address ‘3’ on the D bus of the bus 88, and the end address ‘6’ on the D bus of the bus 198, the BNY address ‘3, 4, 5, 6’ are stored in a sub-controller 199 in the D controller. The scheduler 212 then updates the register 86 in the D IRB 200, wherein the selector 85 in the D IRB selects the output of the incrementor 84 in the D IRB so that the read pointer 88 in the D IRB is the value is the SBNY value ‘6’ on the bus 75 plus ‘1’ which is ‘7’, which is the starting address of the next instruction block. At the same time, the scheduler 212 also updates the flag unit 152 in the D IRB 200, since the read pointer crosses the branch point of the BNY address ‘6’, so that the flag write pointer 138 in the flag unit 152 is shifted by one bit to the right, and ‘0’ is written in the bit of the flag 140 pointed to by the write pointer 138. The new flag 140 and the new flag write pointer 138 are placed on the D bus of the bus 168. The flag unit 152 also sets the ready signal D to ‘ready’ and the allocator 211 requests ROB 210 Block 190 for the allocation of the ROB based on the ready signal, and reads the target register address in the ROB block with higher branch level for hazard detection. The read pointer 88 of the D IRB 200 also reads the next entry from the track row 151 where the BN1X field 72 address and the BNY field 73 address are placed on the D bus in the bus 157 to each IRB 200 for matching. The SBNY field 75 in this entry is placed on the bus D of the bus 198 as the end address. The subtractor 121 obtains the read width 65 by subtracting the value on the field 75 by the value on the read pointer 88 and adding ‘1’. The start address is sent via the D bus of bus 88 and the end address is sent via bus D on the bus 198. And the read width is sent via the D bus of bus 65 to scheduler 212, allocator 211 and ROB 210. The operation are similar of the above to allocate resources for the next μOp segment.

The scheduler 212 queries the operand valid signal in the field 203 in the 3, 4, 5, and 6 entries in the D IRB 200 according to the BNY address stored in the sub-controller 199 in D controller therein. Dispatch the μOps in the entry with the largest BNY first, because that entry may store branch μOp. At this point, if all the operands in the entry with BNY of 5 are valid, the scheduler 212 selects the queue 208 of the execution unit 218 that can execute the operation type according to the operation type of the field 202 in the entry, and the IRB number ‘D’ and BNY value ‘5’ are stored into the queue (of course, the following register address, operation, execution unit, etc. can be stored directly into the queue). When the IRB number and the BNY value reach the head of the queue 208, then according to that value, the operation type in the field 202 in the entry with the BNY of “5” in the D IRB 200, the target physical register address in the field 203, the ROB block number ‘U’, BNY ‘5’, and the flags in the sub-controller 199 are read and sent via the bus 215 to the execution unit 218; the operand physical register address and the execution unit number 216 in the field 203, and the flags in the sub-controller 199 are also read and sent to the register file 186 via the bus 196. The register file 186 reads the operand by the operand physical register address and sends it to the execution unit 218 according to the execution unit number via bus 217 for execution. The execution unit 218 executes operations on the operand according to the operation type. Upon completion of the operation, the execution unit 218 stores the execution result into the register file 186 via bus 221 according to the target physical register address sent by the IRB, and sends the ROB block number ‘U’ and BNY ‘5’ to the ROB 210. The ROB 210 sends BNY ‘5’ to the UROB block 190, where the controller 188 subtracts ‘5’ with the start address ‘3’ in its field 176 to get ‘2’, so that the execution status bit 191 in the number 2 entry is set to ‘finished’. The field 194 of entry number 2 has stored the same target physical register address in which by the operation result is written. The ROB block 190 commits via the commit FIFO in the order of the branch level with the flags as previously described. When an entry in the ROB block is committed, the addresses in fields 193 and 194 in the entry are sent to allocator 211 via bus 126. The allocator 211 maps the architecture register address in the field 193 to the physical register address in the field 194 in its register alias table, i.e. the subsequent access to the architecture register recorded in the field 193 accesses the physical register recorded in the field 194. It is possible to optimize the structure that not storing the target physical register address in the 203 field of the IRB 200, but when the queue 208in the allocator 212 is sending the operation type and operand via the bus 215 to the execution unit 218 for execution, it also sends the unit number that is being executed by 218 to the physical register 186; sending the execution unit number of 218 along with the ROB block number ‘U’ and the BNY address to the reorder buffer 210 to read the target physical register address to send to the physical register 186; the execution result of the 218 is matched with the physical register address from 210 in 186 according to the execution unit number of 218, and the address is used to store.

The branch unit 219 executes branch μOp and generates branch decision 91. The branch unit 219 also generates a flag read pointer 171, which moves right by one bit each time a branch μOps is executed. The branch unit 219 sends the branch decision 91 and the flag read pointer 171 to the allocator 211, the scheduler 212, the ROB 210, the execution unit 218, 185, etc., and the physical register 186. The flag read pointer 171 selects one bit of all the valid flags in each unit to compare with the branch decision 91, where the operations on 211, 218, 185, 186 are similar to those of the embodiment in FIG. 21; the operation method of 212 has been explained in the embodiment of FIG. 26, and the operation method of 210 has been illustrated in the embodiment of FIG. 23. The μOp segments with ‘different’ comparison results are aborted and their resources are released. The μOp segments with ‘same’ comparison results continue to be executed. The ROB 210 is further compared, and if the flag read pointer 171 is equal to the flag write pointer 138 of a certain ROB block, then that ROB block is committed, and then the ROB block is released. The branch unit 219 generates a branch target address when executing the indirect branch μOp, which address is sent to the L2 tag unit 20 to match via the bus 18, the selector 95 and the bus 19.

When the unconditional branch μOp issues, it does not need to issue its subsequent μOp. The controller in the IRB 200 (similar to 87 of the previous embodiment) detects the type field 71 of each entry in its track except the rightmost column (the end track point). In the case of an unconditional branch type, the register 86 in the operation tracker is not updated after sending the address of the corresponding μOp address via the 198 bus, that is, the μOp after the unconditional branch μOp is not issued. So that the μOps of other traces can use the resources in the processor. In this optimization, the branch unit 219 executes unconditional branch μOps as usual, generates a branch decision 91 value ‘1’ and a flag read pointer 171. Under this situation, the branch attribute ‘0’ branch and its children, grandchildren flag after the unconditional branch do not exist. And the processor resources are all used on the branch attribute ‘1’ branch and its son, grandson flag after the unconditional branch.

Another optimization can be used to create flag read pointer 171 in each unit, where the branch unit only needs to send a stepping signal to each unit after executing a branch instruction or a branch operation to make the flag read pointer of each unit move to the right by a bit. All flag read, write, and issue pointers can keep synchronized by resetting to point to the same flag bit when the system starts

The operation above is performed by the tracker in the IRB 200 reading the branch target in the track row 151 and passing it to each IRB 200 via bus 157 so that the μOp is read from the cache system into the IRB register. The IRB 200 divides the μOps into μOp segments ending with branch μOp, and provides the start address 88 and the end address 75 of the μOp segments. The IRB 200 also generates a ready signal for each μOp segment based on the branch level and branch attribute of the μOp segment, and generates the flag 140 and the branch write pointer 138 to send to the allocator 211, the scheduler 212, and the ROB 210 via the flag bus 168 respectively. The allocator 211 allocates resources according to the flag for the μOp segment, with the resources including the physical register 186 and the ROB block 190 in the ROB 210. The scheduler 212 issues the μOps according to the order of branch level in the flag and fetches the operand from the physical register 186 to the execution unit 185, and the execution result is written into the physical register 186, and the execution state is recorded in the ROB 210. The branch unit 219 executes the branch μOp, generates branch decision 91 and the read pointer 171 and sends them to the allocator 211, the scheduler 212, the execution units 185, 218, etc., the physical register 186, and the ROB 210. μOps that do not comply with the execution trace of the program should be abandoned in all pipelines from the source. Finally, ROB 210 commits the execution result of the μOp that fully complies with the program execution trace to the allocator 211. The allocator 211 renames the physical register address of the execution result to the architecture register address and completes the retirement of the μOps.

The present embodiment forms a clear address mapping relationship between instruction sets of different addressing rules, extracts the control flow information embedded in the instruction, and stores the control flow net. A plurality of address pointers are used to automatically pre-fetch instructions to store into the upper level memory from the low-level memory automatically stored along the stored control flow net, and each address pointer can read the instructions in all possible execution traces within certain control node (branch) level from a multi read-port high-level memory following the said program control flow net, and send all of the instructions to the processor core for a full speculate execution. The above range size setting depends on the time delay at which the processor core makes branch decisions. In this embodiment, the possible subsequent instructions/μOps of the instructions/μOps in each memory level are at least in, or is being stored in the memory one level lower. In the high-level memory that the processor core can access directly, the address mapping between instruction sets with different addressing rules has been completed and can be addressed directly by the address pointer used internally by the processor. The present embodiment synchronizes the operations of the functional units of the processor system with a hierarchical branch flag system. The address pointer assigns a flag with a range branch history based on the branch level according to the branch trace and the branch attribute. Each speculate executed instruction has it corresponding flag when it is stored temperately or operated in the processor core. The scheduler issues instructions in the order according to the branch level in the flag, and can decide the priority sequence of the different traces in the same branch level according to the branch attribute of the instruction and its branch prediction value, and can also dispatch the branch instruction first. The branch unit executes a branch instruction and produces branch decision with branch level mark. The level branch decision is compared with the flags of each pointer and each instruction at the same branch level, so that the processor core aborts the instructions at the branch level with branch attributes differing from the branch decision and instructions in their child and grandchild branches, and continue executing the instructions at the branch level with the same branch attributes as the branch decision and instructions in their child and grandchild branches. The resources occupied by the pointers and instructions which are abandoned by the branch decision are used for the child and grandchild branches of the pointers and instructions that continue to be executed. Repeating the above, the processor system of this embodiment is capable of executing the μOps translated from instruction non-stop, hiding the branch delay and branch penalty, and the cache miss is also lower than the existing processor system employing μOp caches.

It should be understood that the various components listed in the above embodiments are for ease of description only and other components may be included, some components may be combined or omitted. The described components may be distributed in a plurality of systems physically or virtually, and can be implemented by hardware (such as the integrated circuits), software, or the combination of hardware and software.

It is understood by one skilled in the art that many variations of the embodiments described herein are contemplated. While the invention has been described in terms of an exemplary embodiment, it is contemplated that it may be practiced as outlined above with modifications within the spirit and scope of the appended claims.

1-38. (canceled)

39. A multi-issue processor system comprised of:
at least a processor core which is capable of execute a plurality of micro-operations simultaneously;
an instruction convertor, which converts instructions into micro-operations, and wherein generates the mapping relationship between the instruction addresses and the micro-operation instructions;
a mapping unit, which maps instruction addresses produces by the processor core to micro-operation addresses based on the said mapping relationship, to address an micro-operation memory;
a micro-operation memory, which stores the converted micro-operations, and outputs a plurality of micro-operations to the processor core for execution.
